(19) United States
(12) Patent Application Publication
(10) Pub. No.: US 2026/0064109 A1
(43) Pub. Date: Mar. 5, 2026

(54) SYSTEM AND METHOD FOR PREDICTING MECHANICAL DAMAGE FROM THERMAL FATIGUE USING NEURAL NETWORKS

(71) Applicant: Black Lambo LLC, Roswell, GA (US)

(72) Inventor: Benjamin Turner, Roswell, GA (US)

(21) Appl. No.: 19/298,552

(22) Filed: Aug. 13, 2025

Related U.S. Application Data
(60) Provisional application No. 63/687,903, filed on Aug. 28, 2024.

(51) Int. Cl. G05B 23/02

(52) U.S. Cl. CPC G05B 23/0254

(57) ABSTRACT

A system may comprise a neural network trained to predict mechanical damage to field-deployed industrial equipment with a main or supplementary function to transfer heat change phase, or drive/limit a reaction. The neural network may be trained using an idealized geometry. A processor may receive process input data from the equipment and may provide the data to the trained neural network. The processor may generate a prediction of mechanical damage using the trained neural network and the process input data. The process input data may comprise temperature data collected during operation. A scanning device may generate a digital twin of at least a portion of the equipment through scanning and ultrasonic testing. A monitoring module may monitor processes through a control system to collect the process input data. The neural network may comprise a convolutional neural network configured to calculate damage using a surrogate model.

### RELATED APPLICATION

Under provisions of 35 U.S. C. § 119(e), the Applicant claims benefit of U.S. Provisional Application No. 63/687,903 filed on Aug. 28, 2024, and having inventors in common, which is incorporated herein by reference in its entirety.

It is intended that the referenced application may be applicable to the concepts and embodiments disclosed herein, even if such concepts and embodiments are disclosed in the referenced application with different limitations and configurations and described using different examples and terminology.

### FIELD OF DISCLOSURE

The present disclosure generally relates to systems and methods for predicting mechanical damage in industrial equipment. More specifically, the disclosure pertains to neural network-based approaches for assessing thermal fatigue-induced damage in heat exchangers, reactors, columns, reboilers and any other equipment with a main or supplementary function to transfer heat, change phase, and/or drive/limit a reaction using real-time process data and idealized geometry models.

### BACKGROUND

Mechanical damage from thermal fatigue may be a significant concern in industrial equipment such as heat exchangers, reactors, columns, reboilers and any other equipment with a main or supplementary function to transfer heat, change phase, and/or drive/limit a reaction. Conventional methods for assessing such damage may involve extensive data collection and complex modeling using finite element analysis. These traditional approaches may be time-consuming and often reactive, addressing issues only after failures have occurred. This may lead to increased downtime and higher repair costs.

Conventional thermal fatigue assessment systems typically rely on periodic manual inspections and scheduled maintenance protocols. These systems often employ visual inspection techniques to identify surface cracks and deformation in industrial equipment components. Traditional monitoring approaches may utilize thermocouples and pressure sensors to collect basic operational parameters. However, such systems generally operate on predetermined maintenance schedules rather than actual equipment condition.

Many existing assessment methods depend heavily on finite element analysis software to model thermal stress distributions. These computational approaches require detailed geometric modeling of each component. The modeling process typically involves creating complex mesh structures to represent the physical equipment. Finite element simulations may require substantial computational resources and processing time to generate results.

Current damage evaluation techniques often focus on post-failure analysis rather than predictive assessment. Inspection personnel may conduct ultrasonic testing and other non-destructive evaluation methods during scheduled outages. These conventional approaches typically generate large datasets that require manual interpretation by experienced engineers. The analysis process may involve comparing measured parameters against established failure criteria and industry standards.

Existing monitoring systems frequently operate as standalone units with limited integration capabilities. Data collection may occur through separate measurement devices that are not connected to plant control systems. The resulting information often requires manual compilation and analysis to assess equipment condition. Traditional approaches may not provide continuous monitoring capabilities during normal plant operation.

Conventional thermal fatigue damage evaluation may require manual interpretation of measurement data by qualified personnel. Experienced engineers typically analyze collected information against established failure criteria from industry standards. The interpretation process may involve correlating multiple data sources to assess overall equipment condition. Manual analysis approaches often introduce subjective variations in damage assessment results.

Traditional monitoring approaches may face challenges in processing complex temperature variations during equipment operation. Temperature fluctuations from normal operational cycles can create significant data interpretation difficulties. Conventional systems may struggle to distinguish between normal thermal variations and potentially damaging thermal stress patterns. The complexity of temperature data analysis may require specialized expertise that is not always readily available.

Existing damage assessment workflows often lack standardized procedures for correlating thermal measurements with mechanical damage progression. Different assessment methodologies may produce inconsistent results when applied to similar equipment conditions. The absence of standardized evaluation criteria can lead to varying maintenance decisions across different facilities. Inconsistent assessment approaches may result in either premature equipment replacement or unexpected failures.

Current approaches to welded component evaluation may have limitations in early damage detection capabilities. Welded joints in equipment represent critical failure points that require specialized monitoring techniques. Conventional inspection methods may not detect incipient damage in welded areas until significant degradation has occurred. Early-stage damage in welded components may progress rapidly once initiated, making timely detection challenging.

Many existing systems may operate with limited integration to plant control infrastructure. Separate monitoring devices often generate isolated datasets that require manual correlation with operational parameters. The lack of integration may prevent comprehensive assessment of equipment condition during varying operational states. Disconnected monitoring approaches may not capture the full operational context needed for accurate damage evaluation.

Traditional computational approaches for thermal stress analysis may require substantial processing time that limits real-time application. Complex finite element simulations often demand extensive computational resources that may not be available for continuous monitoring. The computational intensity of conventional methods may make them impractical for real-time damage assessment during normal plant operation. Processing delays in traditional approaches may prevent timely maintenance decisions when equipment condition changes rapidly.

The limitations of conventional approaches may become particularly apparent when attempting to implement continuous monitoring during normal plant operation. Traditional finite element analysis methods typically require offline processing that prevents real-time damage assessment. The computational demands of conventional modeling approaches may exceed the processing capabilities available in typical industrial control environments.

Current thermal fatigue evaluation methodologies may lack the capability to process temperature data in real-time while equipment remains in service. Conventional systems typically require equipment shutdown for comprehensive damage assessment. The inability to perform continuous monitoring during operation may result in missed opportunities for preventive maintenance interventions.

Existing damage prediction approaches may struggle with the complexity of correlating thermal cycling patterns with mechanical degradation in welded components. Traditional methods often rely on simplified thermal models that may not accurately represent actual equipment behavior. The gap between theoretical models and real-world equipment performance may lead to inaccurate damage predictions.

Many conventional monitoring systems may operate with insufficient integration to existing plant control infrastructure. Traditional approaches often require separate data acquisition systems that operate independently from plant control networks. The lack of integration may prevent automated response to changing equipment conditions.

Current approaches to thermal stress evaluation may face challenges in processing the dynamic nature of industrial equipment operations. Temperature variations during normal operational cycles can create complex thermal stress patterns that are difficult to analyze using conventional methods. Traditional assessment techniques may not adequately account for the cumulative effects of repeated thermal cycling.

Existing damage assessment methodologies may lack the speed required for real-time industrial applications. Conventional finite element simulations typically require hours or days to complete comprehensive damage evaluations. The processing time requirements of traditional methods may make them unsuitable for continuous monitoring applications where rapid assessment is required.

Current approaches to welded component monitoring may have limitations in detecting early-stage damage progression. Traditional inspection methods often cannot identify incipient damage until it has progressed to detectable levels. The delay in damage detection may result in unexpected equipment failures that could have been prevented with earlier intervention.

Many existing systems may operate without standardized procedures for integrating thermal measurements with damage prediction models. Different facilities may employ varying assessment criteria that produce inconsistent results. The absence of standardized evaluation approaches may lead to suboptimal maintenance decisions across industrial operations.

Traditional computational methods for thermal fatigue analysis may require specialized software and expertise that are not readily available in all industrial facilities. Conventional approaches often demand significant training and experience to implement effectively. The complexity of traditional methods may limit their practical application in routine equipment monitoring.

Therefore, there exists a need for improved systems and methods that can provide real-time thermal fatigue damage assessment capabilities for industrial equipment while overcoming the limitations of conventional approaches.

### BRIEF OVERVIEW

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

A method may be provided for predicting mechanical damage from thermal fatigue in industrial equipment. The method may comprise training a physics-informed graph neural network to predict mechanical damage to at least a portion of a field-deployed heat exchanger, reactor, column, reboiler and/or any other equipment with a main or supplementary function to transfer heat, change phase, and/or drive/limit a reaction. The neural network may be trained based on an idealized geometry of the field-deployed industrial equipment. The method may further comprise receiving, by a processor, process input data from the field-deployed industrial equipment. The processor may input the process input data into the trained neural network. The processor may generate, using the trained neural network, a prediction of mechanical damage based on the process input data.

The method may further comprise generating a digital twin of at least a portion of the field-deployed industrial equipment through scanning and ultrasonic testing of the portion. The method may additionally comprise monitoring online processes through an existing control system to collect the process input data from the field-deployed industrial equipment. The physics-informed graph neural network may comprise a convolutional neural network configured to rapidly calculate damage using a surrogate model based on the idealized geometry. The method may further comprise repeating the receiving, inputting, and generating at predefined intervals to perform real-time damage monitoring of the field-deployed industrial equipment.

A system may be provided for predicting mechanical damage from thermal fatigue in industrial equipment. The system may comprise a physics-informed graph neural network trained to predict mechanical damage to at least a portion of a field-deployed industrial equipment, (e.g., a heat exchanger, reactor, column, reboiler, and/or any other equipment with a main or supplementary function to transfer heat, change phase, and/or drive/limit a reaction). The neural network may be trained based on an idealized geometry of the field-deployed industrial equipment. The system may further comprise a processor configured to receive process input data from the field-deployed industrial equipment. The processor may be configured to input the process input data into the trained neural network. The processor may be configured to generate, using the trained neural network, a prediction of mechanical damage based on the process input data.

The system may further comprise a scanning device configured to generate a digital twin of the portion of the field-deployed industrial equipment through scanning and ultrasonic testing of the portion. The system may additionally comprise a monitoring module configured to monitor online processes through an existing control system to collect the process input data from the field-deployed industrial equipment. The physics-informed graph neural network may comprise a convolutional neural network configured to rapidly calculate damage using a surrogate model based on the idealized geometry. The processor may be further configured to repeat the receiving, inputting, and generating at predefined intervals to perform real-time damage monitoring of the field-deployed industrial equipment. The processor may be further configured to process the prediction of mechanical damage using a damage decision workflow to determine one or more appropriate actions to be performed based on the prediction of mechanical damage. The processor may be further configured to cause performance of at least one of the one or more appropriate actions.

A method may be provided for real-time assessment of thermal fatigue damage in industrial equipment, (e.g., a heat exchanger, reactor, column, reboiler, and/or any other equipment with a main or supplementary function to transfer heat, change phase, and/or drive/limit a reaction) components. The method may comprise capturing three-dimensional geometry data of at least a portion of field-deployed industrial equipment using a scanning device. The method may further comprise performing ultrasonic testing of the portion to detect internal structural characteristics. The method may comprise constructing a digital twin model of the portion based on the three-dimensional geometry data and ultrasonic testing results. The method may further comprise training a physics-informed graph neural network on the digital twin model to learn thermal stress patterns in the portion. The method may comprise continuously monitoring temperature variations at the portion during industrial equipment operation. The method may further comprise inputting the temperature variations into the trained physics-informed graph neural network. The method may comprise outputting a real-time assessment of accumulated thermal fatigue damage in the portion of the industrial equipment.

The method may further comprise establishing damage threshold limits for the portion. The method may comprise comparing the real-time assessment of accumulated thermal fatigue damage to the damage threshold limits. The method may comprise generating an alert when the accumulated thermal fatigue damage exceeds a predetermined threshold limit.

The continuously monitoring may comprise sampling temperature data at the portion of the industrial equipment at intervals of less than one minute. The method may comprise filtering noise from the temperature data. The method may comprise normalizing the temperature data for input into the physics-informed graph neural network.

The method may further comprise calculating a rate of damage accumulation based on successive real-time assessments. The method may comprise predicting remaining useful life of the portion of the industrial equipment based on the rate of damage accumulation. The method may comprise scheduling preventive maintenance based on the predicted remaining useful life.

This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope. Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicant. In addition, the drawings may contain other marks owned by third parties and are being used for illustrative purposes only. All rights to various trademarks and copyrights represented herein, except those belonging to their respective owners, are vested in and the property of the Applicant. The Applicant retains and reserves all rights in its trademarks and copyrights included herein, and grants permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. In the drawings:

FIG. 1 illustrates a block diagram of an operating environment consistent with the present disclosure;

FIG. 2 is a flow chart of a method for providing a platform for predicting mechanical damage from thermal fatigue;

FIG. 3 is a flow chart of a method for real-time assessment of thermal fatigue damage in a heat exchanger; and

FIG. 4 is a block diagram of a system including a computing device for performing the method of FIG. 2.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure and are made merely to provide a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of the term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Regarding applicability of 35 U.S. C. § 112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims. The present disclosure contains headers. It should be understood that these headers are used as references and are not to be construed as limiting upon the subject matter disclosed under the header.

Traditional approaches to assessing thermal fatigue damage in industrial equipment (e.g., an industrial equipment, reactor, column, reboiler, and/or any other equipment with a main or supplementary function to transfer heat, change phase, and/or drive/limit a reaction)industrial equipment may present several technical challenges that limit their effectiveness in preventing equipment failures. Conventional damage assessment methods may rely heavily on finite element analysis and complex modeling techniques that require extensive computational resources and time to execute. These approaches may typically involve collecting comprehensive data about equipment geometry, material properties, operating conditions, and environmental factors before performing detailed stress analysis calculations.

In many industrial scenarios, traditional damage assessment may only be conducted after visible signs of deterioration have appeared or after catastrophic failure has occurred. This reactive approach may result in significant operational downtime, costly emergency repairs, and potential safety hazards. For example, in a chemical processing plant industrial equipment operates under high-temperature cycling conditions, traditional assessment methods may require equipment shutdown and physical inspection to evaluate component and/or weld integrity. Such shutdowns may disrupt production schedules and lead to substantial economic losses.

The complexity of traditional finite element modeling may present another significant obstacle to real-time damage monitoring. Each industrial equipment configuration may require the development of a unique computational model that accounts for specific geometric features, material properties, and operating parameters. This modeling process may be time-intensive and may require specialized expertise in both computational mechanics and the particular industrial application. Additionally, these models may need frequent updates as operating conditions change or as equipment ages, further complicating their practical implementation.

Data collection requirements for conventional damage assessment may pose additional challenges in field-deployed equipment. Traditional approaches may necessitate the installation of numerous sensors to monitor multiple parameters such as temperature gradients, pressure variations, flow rates, and mechanical stresses throughout the structure of the industrial equipment. The extensive sensor networks required may increase installation costs, maintenance requirements, and potential points of failure. Furthermore, the large volumes of data generated by these comprehensive monitoring systems may overwhelm conventional data processing capabilities.

In power generation facilities, heat exchangers and other industrial equipment may experience varying thermal loads based on electrical demand fluctuations and seasonal operating patterns. Traditional damage assessment methods may struggle to adapt to these dynamic operating conditions in real-time. The computational burden of continuously updating finite element models to reflect changing operational parameters may exceed the processing capabilities of typical industrial control systems. This limitation may result in damage assessments that lag behind actual equipment conditions, potentially missing critical damage progression phases.

Manufacturing environments may present unique challenges where industrial equipment (e.g., an industrial equipment, reactor, column, reboiler, and/or any other equipment with a main or supplementary function to transfer heat, change phase, and/or drive/limit a reaction) serves multiple production lines with different thermal requirements. Traditional assessment approaches may require separate modeling efforts for each operational scenario, multiplying the computational and maintenance overhead. The inability to rapidly assess damage under varying operational modes may lead to conservative maintenance schedules that result in premature equipment replacement or inadequate protection against unexpected failures.

The integration of traditional damage assessment methods with existing industrial control systems may encounter compatibility issues. Legacy control systems may lack the computational resources necessary to support complex finite element calculations. Additionally, the data formats and communication protocols used by traditional assessment tools may not align with established industrial automation standards, creating barriers to seamless integration.

Welded components in industrial equipment may be particularly vulnerable to thermal fatigue damage due to stress concentrations at weld joints and heat-affected zones. Traditional inspection methods for these critical components may rely on periodic non-destructive testing techniques such as ultrasonic inspection or radiographic examination. However, these inspection methods may only provide snapshots of component condition at specific points in time and may not capture the dynamic progression of damage between inspection intervals.

The primary technical problem addressed by the present system may be the need for real-time, predictive assessment of thermal fatigue damage in field-deployed industrial equipment using simplified input parameters while maintaining accuracy comparable to traditional comprehensive modeling approaches. This problem may be particularly acute in industrial environments where equipment operates continuously under varying thermal conditions and where unplanned shutdowns for damage assessment may result in significant operational and economic impacts.

The present system addresses these technical challenges by providing a comprehensive solution that leverages physics-informed graph neural networks to enable real-time predictive assessment of thermal fatigue damage in field-deployed industrial equipment. The system may transform the conventional reactive approach to equipment maintenance into a proactive, predictive methodology that operates continuously during normal equipment operation.

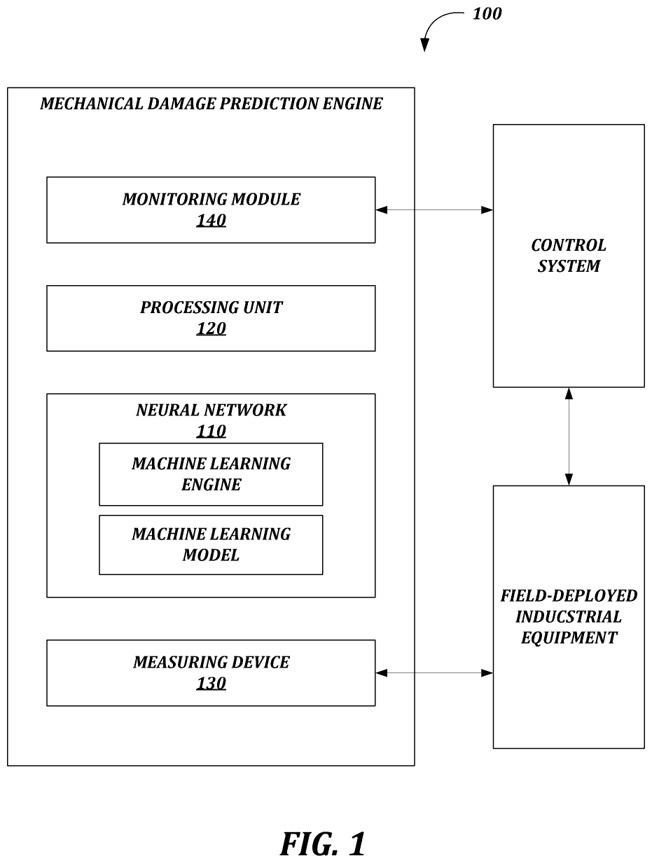

Referring to FIG. 1, the system 100 may comprise four primary interconnected components that work together to provide comprehensive damage prediction capabilities. The neural network 110 may serve as the core analytical engine, utilizing a physics-informed graph neural network architecture that combines the spatial modeling capabilities of graph neural networks with the physical constraint enforcement of physics-informed neural networks. This hybrid approach may ensure that all damage predictions adhere to fundamental thermodynamic principles while maintaining computational efficiency suitable for real-time applications.

The processing unit 120 may orchestrate the overall system operation by receiving and preprocessing sensor data, managing neural network inference operations, and implementing decision workflows based on damage predictions. The processing unit 120 may interface with existing industrial control systems through standardized communication protocols, allowing seamless integration without requiring extensive modifications to established automation infrastructure. The processing unit 120 may also manage data storage, historical trending, and alert generation functions that support comprehensive equipment health monitoring.

The measuring device 130 may provide critical geometric characterization capabilities through advanced scanning and ultrasonic testing technologies. This device 130 may generate high-fidelity digital twins of components during the fabrication or maintenance phases when complete access to equipment geometry may be available. The measuring device 130 may capture both surface topology and internal structural characteristics, providing comprehensive baseline data that serves as the foundation for accurate damage modeling.

The monitoring module 140 may serve as the primary interface between the field-deployed equipment and the damage prediction system. This module 140 may collect real-time process data from existing sensor networks, including temperature measurements, pressure readings, flow rates, and other operational parameters that influence thermal fatigue behavior. The monitoring module 140 may incorporate data filtering and preprocessing capabilities to ensure data quality while minimizing computational overhead in the overall system.

The system may address the computational complexity limitations of traditional finite element analysis by utilizing a surrogate modeling approach based on idealized geometries. During the training phase, the neural network 110 may learn the relationships between operational parameters and damage progression using comprehensive finite element models of idealized industrial equipment configurations. Once trained, the neural network 110 may rapidly predict damage states using only simplified input parameters, typically consisting primarily of temperature data collected from field-deployed sensors.

This approach may provide several advantages over conventional assessment methods. The system may operate continuously during normal equipment operation without requiring shutdowns or physical inspections. The neural network 110 may process sensor data in real-time, providing immediate feedback on equipment condition and enabling rapid response to developing damage conditions. The physics-informed constraints built into the neural network architecture may ensure that predictions remain thermodynamically consistent, preventing unrealistic damage assessments that could lead to inappropriate maintenance decisions.

The system may be particularly effective in addressing thermal fatigue damage in welded components, which may represent critical failure points in industrial equipment systems. The measuring device 130 may capture detailed geometric information about weld profiles, heat-affected zones, and potential manufacturing defects that influence damage susceptibility. This geometric data may be incorporated into the digital twin models that serve as the basis for neural network training, ensuring that damage predictions account for the specific characteristics of individual welded joints.

In power generation applications, the system may adapt to varying operational demands by continuously monitoring temperature fluctuations and updating damage assessments accordingly. The neural network 110 may account for the cumulative effects of thermal cycling, including both high-amplitude, low-frequency cycles associated with plant startup and shutdown operations, and low-amplitude, high-frequency cycles that occur during normal load following operations. This comprehensive approach may provide more accurate damage assessments than traditional methods that may focus on individual cycle types in isolation.

The system may integrate with existing maintenance management systems through standardized data interfaces, enabling automated scheduling of preventive maintenance activities based on predicted damage progression. The processing unit 120 may implement configurable damage decision workflows that consider operational priorities, spare parts availability, and maintenance resource constraints when generating maintenance recommendations. This integration may optimize maintenance timing to minimize operational disruptions while ensuring equipment reliability.

For chemical processing applications where industrial equipment may operate under corrosive conditions, the system may account for the synergistic effects of thermal fatigue and corrosion damage. The neural network 110 may be trained on datasets that include both thermal cycling effects and chemical degradation mechanisms, providing comprehensive damage assessments that reflect the complex operating environment. The monitoring module 140 may collect additional sensor data related to chemical composition and corrosion rates to enhance prediction accuracy in these challenging applications.

The system may provide scalability advantages in manufacturing environments where multiple industrial equipment may serve different production processes. A single processing unit 120 may manage multiple monitoring modules 140, each associated with different equipment units or process lines. The neural network 110 may be configured to handle varying operational parameters across different applications while maintaining prediction accuracy for each individual industrial equipment item.

The present disclosure includes many aspects and features. Moreover, while many aspects and features relate to, and are described in, the context of a platform for predicting mechanical damage from thermal fatigue, embodiments of the present disclosure are not limited to use only in this context.

### I. Platform Overview

This overview is provided to introduce a selection of concepts in a simplified form that are further described below. This overview is not intended to identify key features or essential features of the claimed subject matter. Nor is this overview intended to be used to limit the claimed subject matter's scope.

The platform 100 for predicting mechanical damage from thermal fatigue may comprise a neural network trained on an idealized geometry. The neural network may be configured to predict mechanical damage from thermal fatigue. The platform may include a processor configured to receive process input data from field-deployed industrial equipment (e.g., heat exchangers, reactors, columns, reboilers and any other equipment with a main or supplementary function to transfer heat, change phase, and/or drive/limit a reaction). The processor may input the process input data into the trained neural network. The trained neural network may generate a prediction of mechanical damage based on the process input data.

The process input data may comprise (but need not be limited to) temperature data from the field-deployed industrial equipment. In some embodiments, the platform may include a scanning device configured to generate a mechanical twin of industrial equipment or portions thereof (e.g., a welded part) through scans and ultrasonic testing (UT). A monitoring module may be included in the platform for monitoring online processes through an existing control platform.

The neural network may comprise a convolutional neural network. The convolutional neural network may be configured to rapidly calculate damage using a surrogate model. In particular, the processor may be further configured to perform real-time damage monitoring. The processor may also be configured to process the prediction of mechanical damage using a damage decision workflow.

The platform may employ physics-informed and graph convolutional networks to predict local thermal stress. The graph convolutional network may treat the surface as a platform of interrelated points, forming a mesh. The physics-informed portion of the neural network architecture may apply a real physical constraint to the solution spaces. For example, the Laplace equation may be used as a physics-informed constraint. This constraint may ensure that all solution spaces predicted by the graph convolutional network fulfill this criteria, potentially preventing non-physical solutions from being discovered.

The platform may combine graph neural networks (GNNs) and physics-informed neural networks (PINNs) to form a physics-informed graph neural network (PI-GNN). This combination may be particularly suited for training AI with finite element analysis.

The platform may allow for the creation of a digital twin of a component being monitored. In some embodiments, the digital twin may be created at the fabrication stage of the actual component, once all of the needed data for the actual object is available. This approach may enable assessment of potential failure before it occurs, potentially providing an advantage over traditional methods that often assess failure only after it has occurred.

Embodiments of the present disclosure may comprise methods, systems, and a computer readable medium comprising, but not limited to, at least one of the following:
A. Neural Network;
B. Processing Unit;
C. Measuring Device;
D. Monitoring Module; and
E. Alternative Configurations.

Details with regard to each module are provided below. Although modules are disclosed with specific functionality, it should be understood that functionality may be shared between modules, with some functions split between modules, while other functions duplicated by the modules. Furthermore, the name of each module should not be construed as limiting upon the functionality of the module. Moreover, each component disclosed within each module can be considered independently, without the context of the other components within the same module or different modules. Each component may contain functionality defined in other portions of this specification. Each component disclosed for one module may be mixed with the functionality of other modules. In the present disclosure, each component can be claimed on its own and/or interchangeably with other components of other modules.

The following depicts an example of a method of a plurality of methods that may be performed by at least one of the aforementioned modules, or components thereof. Various hardware components may be used at the various stages of the operations disclosed with reference to each module. For example, although methods may be described to be performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components as found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in orders that differ from the ones disclosed below. Moreover, various stages may be added or removed without altering or departing from the fundamental scope of the depicted methods and systems disclosed herein.

Consistent with embodiments of the present disclosure, a method may be performed by at least one of the modules disclosed herein. The method may be embodied as, for example, but not limited to, computer instructions which, when executed, perform the method. The method may comprise the following stages:
training a neural network to predict mechanical damage to at least a portion of field-deployed industrial equipment, wherein the neural network is trained based on an idealized geometry of the field-deployed industrial equipment;
scanning portions of the industrial equipment to form digital models representing the scanned portions
receiving process input data from the field-deployed industrial equipment;
inputting, by the processor, the process input data into the trained neural network;
generating, by the processor using the trained neural network, a prediction of mechanical damage based on the process input data;
determining one or more appropriate actions to be taken based on the generated prediction of mechanical damage; and
causing performance of at least one of the one or more appropriate actions.

Although the aforementioned method has been described to be performed by the platform 100, it should be understood that computing device 400 may be used to perform the various stages of the method. Furthermore, in some embodiments, different operations may be performed by different networked elements in operative communication with computing device 400. For example, a plurality of computing devices may be employed in the performance of some or all of the stages in the aforementioned method. Moreover, a plurality of computing devices may be configured much like a single computing device 400. Similarly, an apparatus may be employed in the performance of some or all stages in the method. The apparatus may also be configured much like computing device 400.

Both the foregoing overview and the following detailed description provide examples and are explanatory only. Accordingly, the foregoing overview and the following detailed description should not be considered to be restrictive. Further, features or variations may be provided in addition to those set forth herein. For example, embodiments may be directed to various feature combinations and sub-combinations described in the detailed description.

### II. Platform Configuration

FIG. 1 illustrates one possible operating environment through which a platform for predicting mechanical damage from thermal fatigue in industrial equipment (e.g., a heat exchanger, reactor, column, reboiler, and/or any other equipment with a main or supplementary function to transfer heat, change phase, and/or drive/limit a reaction) consistent with embodiments of the present disclosure may be provided. In some embodiments, the platform 100 may include a neural network 110, a processing unit 120, a measurement device 130, and a monitoring module 140.

The neural network 110 may comprise a physics-informed graph neural network architecture that combines the computational efficiency of graph neural networks with the physical constraint enforcement capabilities of physics-informed neural networks. This hybrid approach may enable the system to process complex geometric data while ensuring that all predictions remain consistent with fundamental thermodynamic principles. The physics-informed graph neural network may treat the industrial equipment surface as a collection of interconnected nodes forming a computational mesh, where each node may represent a specific location on the equipment surface.

The graph convolutional network component of the neural network 110 may process spatial relationships between different regions of the industrial equipment by analyzing the connectivity patterns within the mesh structure. Each node in the graph may contain information about local temperature conditions, material properties, and geometric characteristics that influence thermal fatigue behavior. The graph convolution operations may propagate information between neighboring nodes, allowing the network to capture the spatial dependencies that govern heat transfer and stress distribution throughout the equipment.

The physics-informed constraints within the neural network 110 may be implemented through the incorporation of partial differential equations that govern thermal behavior in solid materials. The Laplace equation may serve as a primary constraint, ensuring that temperature distributions predicted by the network satisfy fundamental heat conduction principles. Additional constraints may include energy conservation laws, thermal expansion relationships, and stress-strain constitutive equations that relate thermal loading to mechanical damage accumulation.

The neural network 110 may utilize a multi-scale architecture that processes information at different levels of geometric detail. Coarse-scale features may capture overall temperature gradients and thermal cycling patterns across the entire industrial equipment, while fine-scale features may focus on localized stress concentrations around welded joints and geometric discontinuities. This multi-scale approach may enable the network to simultaneously consider both global operational conditions and local damage mechanisms.

The training process for the neural network 110 may involve the use of synthetic datasets generated from finite element analysis models of idealized industrial equipment geometries. These idealized geometries may represent simplified versions of actual industrial equipment configurations, incorporating the most significant geometric features while eliminating minor details that may not substantially influence thermal fatigue behavior. The use of idealized geometries during training may enable the neural network to generalize across different industrial equipment designs while maintaining computational efficiency.

The neural network 110 may incorporate attention mechanisms that automatically identify the most relevant input features for damage prediction in different operational scenarios. These attention weights may adapt dynamically based on the specific temperature patterns and operational conditions present in the input data. The attention mechanism may help the network focus on critical temperature fluctuations that contribute most significantly to thermal fatigue damage accumulation.

The output layer of the neural network 110 may generate multiple types of damage-related predictions simultaneously. These outputs may include instantaneous damage rates, cumulative damage fractions, remaining useful life estimates, and confidence intervals associated with each prediction. The multi-output structure may provide comprehensive information about equipment condition while quantifying the uncertainty associated with each assessment.

The neural network 110 may implement regularization techniques to prevent overfitting and ensure robust performance across different operational conditions. These techniques may include dropout layers, batch normalization, and weight decay mechanisms that encourage the network to learn generalizable patterns rather than memorizing specific training examples. The regularization approach may be particularly important given the physics-informed constraints that limit the solution space available to the network.

The processing unit 120 may serve as the central orchestration component that manages data flow between the various system modules and coordinates the overall damage assessment workflow. The processing unit 120 may implement sophisticated data preprocessing algorithms that condition raw sensor data for optimal neural network performance. These preprocessing operations may include noise filtering, outlier detection, data normalization, and temporal smoothing to ensure that input data quality meets the requirements for accurate damage prediction.

The processing unit 120 may maintain a comprehensive database of historical operational data and damage predictions that enables trend analysis and pattern recognition over extended time periods. This historical data repository may support the identification of long-term degradation patterns that may not be apparent from short-term monitoring alone. The processing unit 120 may implement data compression and archival strategies to manage the large volumes of time-series data generated during continuous monitoring operations.

The real-time monitoring capabilities of the processing unit 120 may be implemented through a multi-threaded architecture that enables parallel processing of data from multiple monitoring points simultaneously. Each monitoring thread may operate independently while sharing computational resources and synchronized access to the trained neural network models. This parallel processing approach may ensure that the system can handle high-frequency data acquisition from complex industrial equipment systems without introducing significant latency in damage assessments.

The processing unit 120 may implement adaptive sampling strategies that automatically adjust data collection frequencies based on current equipment conditions and predicted damage rates. During periods of stable operation with low damage accumulation rates, the sampling frequency may be reduced to conserve computational resources and minimize data storage requirements. Conversely, during periods of rapid temperature cycling or high damage accumulation, the sampling frequency may be increased to capture transient phenomena that could influence damage progression.

The damage decision workflow implemented within the processing unit 120 may incorporate multi-criteria decision analysis techniques that consider operational priorities, maintenance resource availability, and economic factors when generating maintenance recommendations. The workflow may evaluate multiple potential response strategies for each damage assessment, ranking alternatives based on their effectiveness in preventing equipment failure while minimizing operational disruptions and maintenance costs.

The processing unit 120 may interface with existing enterprise resource planning systems to automatically generate work orders, schedule maintenance activities, and track spare parts inventory based on damage predictions. This integration capability may enable seamless incorporation of predictive maintenance strategies into established operational procedures. The processing unit 120 may generate standardized reports and documentation that comply with regulatory requirements and industry standards for equipment condition monitoring.

The measuring device 130 may incorporate advanced three-dimensional scanning technologies that capture high-resolution geometric data of components during the fabrication or maintenance phases when complete access to equipment geometry may be available. The scanning system may utilize structured light projection techniques that create detailed surface topology maps with sub-millimeter accuracy. These surface measurements may provide the foundation for creating accurate digital twin models that serve as the basis for neural network training and damage assessment.

The ultrasonic testing capabilities integrated within the measuring device 130 may employ phased array transducer technology that enables comprehensive inspection of the internal structure of the component without requiring multiple sensor repositioning operations. The phased array system may generate cross-sectional images of weld profiles, heat-affected zones, and potential manufacturing defects such as porosity, inclusions, or incomplete penetration. This internal structural information may be incorporated into the digital twin models to enhance the accuracy of damage predictions.

The measuring device 130 may implement automated scanning protocols that ensure consistent data collection procedures across different equipment installations and operator skill levels. These protocols may include predefined scan patterns, calibration procedures, and quality control checks that verify data integrity before digital twin model generation. The automated approach may reduce the potential for human error and ensure that digital twin models meet the accuracy requirements for reliable damage prediction.

The data fusion algorithms within the measuring device 130 may combine surface scanning data with ultrasonic testing results to create comprehensive three-dimensional models that represent both external geometry and internal structure. The fusion process may account for differences in coordinate systems, measurement uncertainties, and data resolution between the different sensing modalities. The resulting integrated models may provide a complete representation of component geometry and material condition.

The measuring device 130 may incorporate portable computing capabilities that enable on-site processing of scanning data and preliminary digital twin model generation. This local processing capability may reduce the time required for data transfer and enable immediate verification of scan quality before equipment access is no longer available. The portable system may include ruggedized hardware designed to operate in industrial environments with challenging temperature, humidity, and vibration conditions.

The monitoring module 140 may implement sophisticated sensor interface capabilities that enable integration with a wide variety of existing industrial instrumentation systems. The module may support multiple communication protocols including analog current loops, digital fieldbus networks, and wireless sensor protocols. This multi-protocol capability may ensure compatibility with legacy sensor installations while enabling integration of modern wireless sensing technologies.

The data acquisition subsystem within the monitoring module 140 may implement high-speed sampling capabilities that capture rapid temperature transients and thermal cycling events that could contribute to fatigue damage accumulation. The sampling rates may be configurable based on the specific thermal response characteristics of different industrial equipment designs and operational requirements. The module may include local data buffering capabilities that prevent data loss during temporary communication interruptions with the processing unit 120.

The monitoring module 140 may incorporate intelligent data filtering algorithms that automatically identify and eliminate sensor malfunctions, calibration drift, and environmental interference that could compromise damage assessment accuracy. These filtering algorithms may utilize statistical process control techniques, sensor redundancy analysis, and physical consistency checks to ensure data quality. The module may generate automated alerts when sensor performance degrades below acceptable thresholds.

The security features implemented within the monitoring module 140 may include encrypted data transmission, authentication protocols, and access control mechanisms that protect against unauthorized system access and data tampering. These security measures may comply with industrial cybersecurity standards and regulations that govern critical infrastructure protection. The module may implement secure key management procedures that enable periodic security credential updates without interrupting monitoring operations.

The monitoring module 140 may support distributed deployment architectures where multiple monitoring units may be networked together to provide comprehensive coverage of large industrial equipment installations. Each monitoring unit may operate autonomously while participating in coordinated data collection and system health monitoring activities. The distributed architecture may provide redundancy and fault tolerance that ensures continued operation even if individual monitoring units experience failures.

Embodiments of the present disclosure provide a software and hardware platform comprised of a distributed set of computing elements, including, but not limited to:

### A. Neural Network

In embodiments, the platform 100 may include a neural network 110. The neural network 110 may be trained on an idealized geometry to predict mechanical damage from thermal fatigue. The neural network 110 may receive process input data (e.g., temperature data) from a field-deployed industrial equipment. The process input data may be used as an input for the neural network 110 to generate a prediction of mechanical damage.

In some embodiments, the neural network 110 may include local and/or remote machine learning models. The process input data may be augmented by the other data types as input. The augmented process input data may be processed by the neural network 110. As a particular example, the platform 100 may employ a locally stored Machine Learning model for the purposes of classifying the process input data (e.g., temperature and/or other data). The process input data may also be exported off-device to a remote server for processing. The remote system may apply machine learning to the data.

In some embodiments, the neural network 110 may include a machine learning engine. Machine learning includes various techniques in the field of artificial intelligence that deal with computer-implemented, user-independent processes for solving problems that have variable inputs.

In some embodiments, the machine learning engine trains a machine learning model to perform one or more operations. Training a machine learning model uses training data to generate a function that, given one or more inputs to the machine learning model, computes a corresponding output. The output may correspond to a prediction based on prior machine learning. In an embodiment, the output includes a label, classification, and/or categorization assigned to the provided input(s). The machine learning model corresponds to a learned model for performing the desired operation(s) (e.g., labeling, classifying, and/or categorizing inputs). For example, the machine learning model may be used in determining a likelihood of failure of a particular device part based on temperatures measured at the device.

In an embodiment, the machine learning engine may use supervised learning, semi-supervised learning, unsupervised learning, reinforcement learning, and/or another training method or combination thereof. In supervised learning, labeled training data includes input/output pairs in which each input is labeled with a desired output (e.g., a label, classification, and/or categorization), also referred to as a supervisory signal. In semi-supervised learning, some inputs are associated with supervisory signals and other inputs are not associated with supervisory signals. In unsupervised learning, the training data does not include supervisory signals. Reinforcement learning uses a feedback system in which the machine learning engine receives positive and/or negative reinforcement in the process of attempting to solve a particular problem (e.g., to optimize performance in a particular scenario, according to one or more predefined performance criteria). In an embodiment, the machine learning engine initially uses supervised learning to train the machine learning model and then uses unsupervised learning to update the machine learning model on an ongoing basis.

In an embodiment, a machine learning engine may use many different techniques to label, classify, and/or categorize inputs. A machine learning engine may transform inputs (e.g., the augmented sensor data) into feature vectors that describe one or more properties (“features”) of the inputs. The machine learning engine may label, classify, and/or categorize the inputs based on the feature vectors. Alternatively or additionally, a machine learning engine may use clustering (also referred to as cluster analysis) to identify commonalities in the inputs. The machine learning engine may group (i.e., cluster) the inputs based on those commonalities. The machine learning engine may use hierarchical clustering, k-means clustering, and/or another clustering method or combination thereof. In an embodiment, a machine learning engine includes an artificial neural network. An artificial neural network includes multiple nodes (also referred to as artificial neurons) and edges between nodes. Edges may be associated with corresponding weights that represent the strengths of connections between nodes, which the machine learning engine adjusts as machine learning proceeds. Alternatively or additionally, a machine learning engine may include a support vector machine. A support vector machine represents inputs as vectors. The machine learning engine may label, classify, and/or categorizes inputs based on the vectors. Alternatively or additionally, the machine learning engine may use a naïve Bayes classifier to label, classify, and/or categorize inputs. Alternatively or additionally, given a particular input, a machine learning model may apply a decision tree to predict an output for the given input. Alternatively or additionally, a machine learning engine may apply fuzzy logic in situations where labeling, classifying, and/or categorizing an input among a fixed set of mutually exclusive options is impossible or impractical. The aforementioned machine learning model and techniques are discussed for exemplary purposes only and should not be construed as limiting one or more embodiments.

In an embodiment, as a machine learning engine applies different inputs to a machine learning model, the corresponding outputs are not always accurate. As an example, the machine learning engine may use supervised learning to train a machine learning model. After training the machine learning model, if a subsequent input is identical to an input that was included in labeled training data and the output is identical to the supervisory signal in the training data, then output is certain to be accurate. If an input is different from inputs that were included in labeled training data, then the machine learning engine may generate a corresponding output that is inaccurate or of uncertain accuracy. In addition to producing a particular output for a given input, the machine learning engine may be configured to produce an indicator representing a confidence (or lack thereof) in the accuracy of the output. A confidence indicator may include a numeric score, a Boolean value, and/or any other kind of indicator that corresponds to a confidence (or lack thereof) in the accuracy of the output.

In embodiments, the neural network 110 may comprise a convolutional neural network. The convolutional neural network may be configured to rapidly calculate damage using a surrogate model. The neural network 110 may perform real-time damage monitoring. The neural network may process the prediction of mechanical damage using a damage decision workflow.

The neural network may be implemented as a physics-informed graph neural network (PI-GNN). The PI-GNN may combine aspects of graph neural networks (GNNs) and physics-informed neural networks (PINNs). The PI-GNN may be suited for training artificial intelligence with finite element analysis. The neural network 110 may combine physics-informed and graph convolutional networks to predict local thermal stress. The graph convolutional network may treat the surface as a system of interrelated points forming a mesh. The physics-informed portion of the neural network architecture may apply a real physical constraint to the solution spaces. As one example, the Laplace equation may be used as a physics-informed constraint, and all solution spaces predicted by the graph convolutional network may fulfill this criteria, preventing solutions that violate the criteria (e.g., those not possible under the physical model) from being discovered.

The neural network 110 may comprise multiple interconnected layers that collectively form a physics-informed graph neural network architecture specifically designed for processing graph-structured thermal data from industrial equipment systems. The input layer of the neural network 110 may receive temperature measurements from field-deployed sensors and convert these scalar values into node feature vectors that represent thermal conditions at specific locations within the industrial equipment geometry. Each input node may contain temperature data along with spatial coordinate information that defines the physical location of the measurement point within the overall industrial equipment structure.

The graph construction layer may transform the discrete sensor measurements into a connected graph representation where nodes correspond to measurement locations and edges represent thermal connectivity relationships between adjacent regions of the industrial equipment. The edge weights in this graph structure may be determined based on geometric proximity and thermal conductivity properties of the materials connecting different measurement points. The graph topology may be dynamically adjusted based on the specific industrial equipment configuration being monitored, allowing the neural network 110 to adapt to different equipment geometries while maintaining consistent thermal relationship modeling.

The graph convolutional layers may implement specialized convolution operations that propagate information between connected nodes in the thermal graph structure. Each graph convolutional layer may apply learnable weight matrices to aggregate information from neighboring nodes while preserving the spatial relationships inherent in the industrial equipment geometry. The graph convolution operations may utilize message passing mechanisms where each node receives weighted contributions from its connected neighbors, enabling the neural network 110 to capture both local thermal gradients and global temperature distribution patterns across the entire industrial equipment system.

The activation functions within the graph convolutional layers may employ rectified linear units that introduce non-linearity while maintaining computational efficiency during real-time inference operations. The activation functions may be applied element-wise to the output of each graph convolution operation, ensuring that the neural network 110 can model complex non-linear relationships between temperature inputs and thermal fatigue damage accumulation. The choice of activation functions may be optimized to prevent gradient vanishing problems during training while maintaining numerical stability across the range of temperature values typically encountered in industrial equipment applications.

The physics-informed constraint layers may implement partial differential equation constraints that enforce fundamental thermodynamic principles throughout the neural network prediction process. The Laplace equation constraint may be embedded within these layers to ensure that predicted temperature distributions satisfy heat conduction principles in solid materials. The constraint enforcement may be implemented through penalty terms in the loss function that penalize predictions violating physical laws, or through hard constraints that directly modify the network outputs to satisfy thermodynamic requirements.

The attention mechanism layers may automatically identify the most relevant temperature measurements and spatial locations for damage prediction in different operational scenarios. The attention weights may be computed based on the current temperature distribution patterns and historical damage accumulation trends, allowing the neural network 110 to focus computational resources on the most critical regions of the industrial equipment. The attention mechanism may implement multi-head attention architectures that simultaneously consider multiple aspects of the thermal data, including temporal temperature variations, spatial temperature gradients, and correlations between different measurement locations.

The feature extraction layers may process the graph-structured thermal data to identify characteristic patterns associated with different types of thermal fatigue damage mechanisms. These layers may implement specialized convolution kernels designed to detect temperature cycling patterns, thermal shock events, and sustained high-temperature exposure conditions that contribute to material degradation. The feature extraction process may operate at multiple temporal scales to capture both rapid thermal transients and long-term temperature trends that influence damage accumulation rates.

The temporal processing layers may incorporate recurrent neural network components that maintain memory of historical temperature patterns and damage states. These layers may utilize long short-term memory units or gated recurrent units to process sequential temperature data and track the evolution of thermal fatigue damage over extended operational periods. The temporal processing capability may enable the neural network 110 to distinguish between different thermal cycling patterns and their respective contributions to cumulative damage accumulation.

The regularization layers may implement dropout mechanisms and batch normalization techniques to prevent overfitting and ensure robust performance across different operational conditions. The dropout layers may randomly deactivate a fraction of neurons during training to encourage the development of distributed representations that do not rely on specific individual neurons. The batch normalization layers may normalize the inputs to each layer to maintain stable training dynamics and accelerate convergence during the neural network training process.

The output layers may generate multiple types of damage-related predictions simultaneously, including instantaneous damage rates, cumulative damage fractions, remaining useful life estimates, and confidence intervals for each prediction. The output layer architecture may implement separate prediction heads for different damage metrics, allowing the neural network 110 to provide comprehensive assessment information while maintaining computational efficiency. The output activation functions may be chosen to ensure that damage predictions remain within physically meaningful ranges and maintain appropriate scaling for integration with downstream decision-making systems.

The network topology may implement a hierarchical structure where lower layers process local thermal information and higher layers integrate global patterns across the entire industrial equipment system. The hierarchical organization may enable the neural network 110 to capture thermal phenomena occurring at different spatial scales, from localized hot spots around individual welds to system-wide temperature distributions influenced by overall operational conditions. The skip connections between non-adjacent layers may facilitate information flow and gradient propagation throughout the deep network structure.

The layer configurations may be optimized based on the specific characteristics of the industrial equipment geometry and operational parameters being monitored. The number of graph convolutional layers may be adjusted to match the complexity of the thermal connectivity patterns in different industrial equipment designs. The hidden layer dimensions may be scaled based on the number of temperature measurement points and the desired prediction accuracy requirements for the specific industrial application.

The neural network 110 may allow creation of generalized models with variable inputs that provide accurate outputs. The neural network 110 may enable processing that is fast enough for use in real-time damage analysis.

The physics-informed graph neural network training process may incorporate mathematical constraints derived from fundamental thermodynamic principles to ensure that all damage predictions remain physically consistent throughout the learning procedure. The training algorithm may implement a multi-objective optimization approach that simultaneously minimizes prediction error on training data while enforcing adherence to physical laws governing heat transfer and thermal stress distribution in solid materials.

The Laplace equation constraint may be integrated into the loss function through a penalty term that measures the deviation of predicted temperature distributions from the steady-state heat conduction equation. The mathematical formulation of this constraint may be expressed as a partial differential equation of the form ∇²T=0, where T represents the temperature field and ∇² denotes the Laplacian operator. The neural network may be trained to ensure that predicted temperature distributions satisfy this constraint at all spatial locations within the industrial equipment geometry.

The loss function may comprise multiple weighted components that collectively guide the neural network training process toward physically meaningful solutions. The primary component may be a standard mean squared error term that measures the difference between predicted and target damage values from the training dataset. The physics-informed component may be implemented as an additional penalty term that quantifies violations of the Laplace equation constraint across the spatial domain of the industrial equipment model.

The weighting factors for different loss function components may be determined through systematic hyperparameter optimization procedures that balance prediction accuracy against physical constraint satisfaction. The physics constraint weighting factor may be initialized at a relatively high value during early training epochs to establish physically consistent solution patterns, then gradually reduced as the network learns to satisfy both data fitting and physical constraint requirements simultaneously.

The optimization procedure may utilize gradient-based algorithms that compute partial derivatives of the combined loss function with respect to all neural network parameters. The gradient computation may account for both the data-driven loss terms and the physics-informed penalty terms, ensuring that parameter updates move the network toward solutions that satisfy both empirical accuracy and physical consistency requirements.

The training algorithm may implement automatic differentiation techniques to compute the spatial derivatives required for evaluating the Laplace equation constraint. The neural network may be designed to output temperature predictions at discrete spatial locations, and finite difference approximations may be used to estimate the second-order spatial derivatives needed for the Laplacian operator evaluation.

The physics-informed training process may incorporate domain decomposition strategies that divide the industrial equipment geometry into smaller subregions where the Laplace equation constraint may be applied independently. Each subregion may have its own constraint weighting factor that may be adjusted based on the local importance of physical accuracy for damage prediction in that specific area of the equipment.

The training procedure may implement adaptive constraint weighting schemes that automatically adjust the relative importance of physics constraints based on the current training progress and constraint satisfaction levels. The weighting factors may be increased when constraint violations exceed predetermined thresholds, and decreased when the network demonstrates consistent adherence to physical principles.

The optimization algorithm may utilize specialized numerical methods for handling the mixed discrete-continuous nature of the physics-informed loss function. The discrete component may arise from the finite number of training data points, while the continuous component may result from the need to satisfy partial differential equation constraints over continuous spatial domains.

The training process may incorporate regularization techniques specifically designed for physics-informed neural networks, including spectral normalization methods that prevent the network from learning solutions with unrealistic high-frequency spatial variations. These regularization approaches may help ensure that the learned temperature distributions remain smooth and physically plausible across the entire industrial equipment geometry.

The mathematical integration of physics constraints may be implemented through residual network architectures that explicitly compute the residual of the Laplace equation at each spatial location. The residual values may be incorporated directly into the loss function, providing a direct measure of how well the neural network predictions satisfy the governing physical equations.

The training algorithm may implement curriculum learning strategies that gradually increase the complexity of physics constraints throughout the training process. Initial training phases may focus on satisfying simplified versions of the physical constraints, with full constraint complexity introduced as the network develops basic competency in temperature field prediction.

The optimization procedure may utilize second-order optimization methods that account for the curvature of the physics-informed loss function landscape. These methods may provide more efficient convergence compared to first-order gradient descent approaches, particularly when dealing with the complex interactions between data fitting and constraint satisfaction objectives.

The physics constraint integration may be implemented through soft constraint approaches that allow small violations of physical laws while penalizing larger deviations. The penalty function may be designed with smooth, differentiable characteristics that facilitate gradient-based optimization while maintaining strong enforcement of physical principles.

The training process may incorporate validation procedures that specifically evaluate the physics consistency of learned solutions on held-out test data. These validation metrics may include measures of Laplace equation residual magnitudes, energy conservation violations, and other physics-based consistency checks that complement standard prediction accuracy metrics.

In alternative embodiments, the system 100 may be configured with different neural network architectures beyond the physics-informed graph neural network implementation. The neural network 110 may comprise a recurrent neural network architecture that processes sequential temperature data to capture temporal dependencies in thermal cycling patterns. The recurrent neural network may utilize long short-term memory cells or gated recurrent units to maintain information about previous temperature states over extended time periods. This temporal modeling capability may enable the system to identify damage patterns that develop over multiple thermal cycles rather than instantaneous conditions alone.

The neural network 110 may alternatively be implemented as a transformer-based architecture that employs attention mechanisms to focus on the most relevant temperature measurements across different spatial locations on the industrial equipment. The transformer architecture may process temperature data from multiple monitoring points simultaneously, automatically learning which sensor locations provide the most informative data for damage prediction at any given time. The attention weights may adapt dynamically based on current operational conditions, allowing the system to emphasize different sensor inputs as thermal conditions change.

In some embodiments, the neural network 110 may comprise an ensemble of multiple neural network models that operate in parallel to provide enhanced prediction accuracy and uncertainty quantification. Each neural network in the ensemble may be trained on different subsets of the training data or with different architectural configurations. The ensemble approach may combine predictions from individual networks using weighted averaging, voting mechanisms, or more sophisticated fusion techniques. The diversity among ensemble members may improve robustness against modeling uncertainties and provide confidence intervals for damage predictions.

In some embodiments, the neural network 110 may be configured with online learning capabilities that enable continuous model updates based on new operational data. The online learning approach may utilize incremental learning algorithms that adapt neural network parameters as new temperature and damage data becomes available. This adaptive capability may improve prediction accuracy over time as the system accumulates experience with specific equipment installations and operational patterns. The online learning may be implemented using techniques such as elastic weight consolidation or progressive neural networks to prevent catastrophic forgetting of previously learned patterns.

### B. Processing Unit

The platform 100 may comprise a processing unit 120. The processing unit 120 may include hardware and/or software configured to perform various functions related to predicting mechanical damage from thermal fatigue. In embodiments, the processing unit may be configured to receive process input data from a field-deployed industrial equipment. This process input data may include temperature data collected from the industrial equipment during operation.

In some embodiments, the processing unit 120 may normalize or otherwise pre-process the received process input data. The process input data may be stored in a structured data format for use by the platform 100 (e.g., via the neural network 110). The processing unit 120 may be configured to input the received process input data into the trained neural network 110.

The processing unit 120 may receive, as an output from the trained neural network 110, a prediction of mechanical damage based on the input process data. This prediction may provide an estimate of the current or future state of mechanical damage in the industrial equipment due to thermal fatigue.

The processing unit 120 may be configured to use the convolutional neural network to rapidly calculate damage using a surrogate model. This surrogate model may allow for quick approximations of complex damage calculations, enabling real-time analysis. In embodiments, the surrogate model may be a digital model utilizing an idealized geometry.

The processing unit 120 may be configured to perform damage monitoring. In embodiments, the processing unit may monitor the industrial equipment in real-time or near real-time. This real-time monitoring may involve periodically, continuously, or substantially continuously processing incoming data from the industrial equipment and updating damage predictions accordingly.

In some embodiments, the processing unit 120 may be configured to process the prediction of mechanical damage using a damage decision workflow. This workflow may involve a series of steps or criteria to assess the severity of the predicted damage and determine one or more appropriate actions to mitigate and/or repair the predicted damage. In some embodiments, the processor may cause at least one of the one or more actions to be performed.

The damage decision workflow may comprise a multi-stage analytical framework that systematically evaluates damage predictions from the neural network 110 and determines appropriate corrective actions based on predefined criteria and operational constraints. The workflow may begin with the receipt of damage assessment data from the neural network 110, which may include instantaneous damage rates, cumulative damage fractions, remaining useful life estimates, and associated confidence intervals for each prediction.

The initial stage of the damage decision workflow may involve threshold comparison operations where the processing unit 120 evaluates the predicted damage levels against predetermined threshold values. The threshold evaluation may utilize multiple damage criteria simultaneously, including absolute damage fraction thresholds that represent specific percentages of useful life consumed, damage rate thresholds that identify accelerating degradation patterns, and time-based thresholds that consider the projected timeline for reaching critical damage levels. Each threshold may be configurable based on the specific industrial equipment application, operational requirements, and maintenance scheduling constraints.

The processing unit 120 may implement a hierarchical threshold structure where different damage levels trigger progressively more intensive response actions. The first threshold level may correspond to early warning conditions where damage accumulation exceeds normal operational expectations but remains within acceptable operational limits. The second threshold level may indicate moderate damage conditions that require increased monitoring frequency and preliminary maintenance planning activities. The third threshold level may represent severe damage conditions that necessitate immediate operational adjustments or emergency maintenance interventions.

The workflow may incorporate confidence-weighted decision algorithms that adjust the severity of recommended actions based on the uncertainty associated with neural network predictions. When prediction confidence levels fall below predetermined thresholds, the workflow may implement conservative decision strategies that err on the side of equipment protection rather than operational optimization. The confidence weighting may be applied through multiplicative factors that modify threshold comparison results, effectively lowering action trigger points when prediction uncertainty increases.

The damage decision workflow may include temporal analysis components that evaluate damage progression trends over extended time periods rather than relying solely on instantaneous damage assessments. The temporal analysis may utilize statistical trend detection algorithms that identify accelerating damage patterns, seasonal variations in damage accumulation rates, and correlations between operational parameters and damage progression. The trend analysis results may influence the urgency and type of recommended actions, with rapidly accelerating damage patterns triggering more immediate response requirements.

The processing unit 120 may implement multi-criteria decision analysis techniques within the workflow that simultaneously consider damage severity, operational impact, maintenance resource availability, and economic factors when generating action recommendations. The multi-criteria analysis may utilize weighted scoring algorithms where each decision factor receives a relative importance weighting based on current operational priorities and constraints. The weighted scores may be combined using mathematical optimization techniques to identify the action alternatives that provide the best overall balance between equipment protection and operational continuity.

The workflow may incorporate operational context awareness capabilities that modify decision criteria based on current equipment operating conditions and planned operational schedules. During periods of high operational demand, the workflow may implement more conservative damage thresholds to minimize the risk of unplanned shutdowns. Conversely, during planned maintenance windows or periods of reduced operational demand, the workflow may allow higher damage accumulation levels while scheduling appropriate maintenance activities.

The damage decision workflow may include automated action prioritization algorithms that rank multiple potential response strategies based on their effectiveness in addressing the predicted damage conditions. The prioritization may consider factors such as implementation time requirements, resource availability, operational disruption potential, and long-term equipment reliability impacts. The ranking algorithms may utilize decision tree structures that systematically evaluate each action alternative against multiple criteria to generate comprehensive priority scores.

The processing unit 120 may implement feedback mechanisms within the workflow that continuously update decision criteria based on the observed effectiveness of previously implemented actions. The feedback system may track the correlation between predicted damage levels, implemented actions, and subsequent equipment performance to refine the accuracy of future decision recommendations. The learning capability may enable the workflow to adapt to the specific characteristics of individual industrial equipment installations and operational patterns over time.

The workflow may incorporate integration interfaces that automatically communicate alerts and/or recommended actions to external maintenance management systems, inventory control systems, and operational scheduling platforms. The integration capability may include standardized data formatting protocols that ensure compatibility with existing enterprise resource planning systems and computerized maintenance management systems. The automated communication may include detailed action descriptions, required resources, estimated implementation timeframes, and expected outcomes for each recommended intervention.

The damage decision workflow may implement escalation procedures that automatically notify appropriate personnel when damage conditions exceed thresholds (e.g., alert thresholds and/or critical thresholds) or when recommended actions are not implemented within specified timeframes. The escalation system may utilize configurable notification hierarchies that route alerts to different organizational levels based on the severity and urgency of the damage conditions. The notification system may support multiple communication channels including email alerts, text messages, automated phone calls, and integration with existing alarm management systems.

The processing unit 120 may maintain comprehensive audit trails within the workflow that document all decision processes, implemented actions, and outcomes for regulatory compliance and continuous improvement purposes. The audit trail may include timestamped records of all damage assessments, threshold comparisons, decision criteria evaluations, and action implementations. The documentation capability may support automated report generation for regulatory submissions, management reviews, and performance analysis activities.

The processing unit 120 may implement alternative data preprocessing approaches that enhance neural network performance under different operational conditions. The processing unit 120 may employ adaptive filtering algorithms that automatically adjust to changing noise characteristics in sensor data. These adaptive filters may utilize least mean squares algorithms, recursive least squares methods, or Kalman filtering techniques to maintain optimal signal quality as environmental conditions vary. The adaptive preprocessing may improve neural network accuracy by ensuring consistent data quality across different operational scenarios.

In alternative embodiments, the processing unit 120 may incorporate data augmentation techniques that artificially expand the training dataset for neural network development. The data augmentation may include adding controlled noise to existing temperature measurements, applying time-domain transformations such as time warping or scaling, or generating synthetic temperature profiles using physics-based models. These augmentation techniques may improve neural network robustness and generalization capability, particularly when limited historical data is available for training.

The processing unit 120 may alternatively implement distributed computing architectures that enable parallel processing of neural network inference across multiple computing nodes. The distributed approach may partition large industrial equipment systems into smaller computational domains, with separate processing nodes handling different geometric regions. This parallel processing capability may enable real-time damage assessment for complex systems with numerous monitoring points while maintaining acceptable computational latency.

The damage decision workflow implemented within the processing unit 120 may incorporate alternative decision-making frameworks beyond simple threshold-based approaches. The workflow may utilize fuzzy logic systems that handle uncertainty and imprecision in damage assessments more effectively than binary decision rules. The fuzzy logic approach may define linguistic variables such as “low damage,” “moderate damage,” and “high damage” with overlapping membership functions. This framework may provide more nuanced maintenance recommendations that account for the inherent uncertainty in damage predictions.

In some embodiments, the damage decision workflow may employ multi-objective optimization techniques that balance competing factors such as equipment reliability, maintenance costs, and operational availability. The optimization framework may utilize genetic algorithms, particle swarm optimization, or other metaheuristic approaches to identify optimal maintenance strategies. The multi-objective approach may generate Pareto-optimal solutions that represent different trade-offs between conflicting objectives, allowing operators to select strategies that align with their specific priorities.

### C. Measuring Device

The system may include a measuring device 130. The measuring device 130 may include hardware and/or software configured to generate a “digital twin” of at least a part of the industrial equipment. This measuring device may utilize various scanning or measuring techniques to capture the physical characteristics of the part. The measuring device may employ optical scanning methods to obtain surface geometry data of the part. Additionally or alternatively, the measuring device may incorporate ultrasonic testing capabilities to gather internal structural information of the part. The ultrasonic testing component of the measuring device 130 may be capable of detecting internal flaws, such as voids or inclusions, which may not be visible through surface scanning alone. This ultrasonic capability may provide valuable information about the internal structure and quality of a weld in the part.

The measuring device 130 may be designed to operate in a non-destructive manner, allowing for examination of the part without causing any damage or alterations to the part or the industrial equipment. The device 130 may be capable of generating a high-resolution three-dimensional model of the part, capturing intricate details of the geometry and surrounding areas.

The scanning process may involve multiple passes of a sensor associated with the measuring device over the part to ensure comprehensive data collection. The measuring device 130 may be equipped with one or more sensors configured to detect variations in material properties, such as density or composition, which may be relevant to the assessment of the structural integrity of the part.

The digital twin generated by the measuring device 130 may serve as a digital model or representation of the physical part. This digital model may include detailed information about the part profile, one or more heat-affected zones, any potential defects or irregularities in the welded structure of the part, and/or other data related to the part.

The measuring device 130 may be designed for portability, allowing for on-site scanning of parts in various industrial settings. The device 130 may be equipped with data storage and/or transmission capabilities to facilitate the integration of the scanned data into the broader damage prediction system.

The measuring device 130 may be calibrated to account for different materials and weld types, ensuring accurate data collection across a range of industrial applications. The device 130 may be designed to operate in challenging environmental conditions, such as high temperatures and/or corrosive atmospheres, which are common in industrial settings where parts are typically found.

The measuring device 130 may incorporate alternative scanning technologies beyond the optical scanning and ultrasonic testing approaches previously described. The device 130 may utilize X-ray computed tomography scanning to generate three-dimensional images of internal structure with enhanced resolution compared to conventional ultrasonic methods. The X-ray scanning capability may detect minute internal defects, porosity distributions, and material density variations that influence thermal fatigue susceptibility. The computed tomography data may be processed to create volumetric digital twin models that represent both surface geometry and internal material characteristics.

In alternative configurations, the measuring device 130 may employ laser interferometry techniques to measure surface deformations and residual stress patterns in components. The interferometric measurements may capture stress concentrations around weld joints that contribute to thermal fatigue initiation. This stress mapping capability may enhance the accuracy of digital twin models by incorporating residual stress effects that result from the welding process. The interferometric data may be integrated with geometric scanning results to create comprehensive digital representations of component condition.

The measuring device 130 may alternatively utilize eddy current testing methods to assess material properties and detect surface or near-surface defects in welded components. The eddy current sensors may scan across weld surfaces to identify variations in electrical conductivity that correspond to material degradation, cracking, or other damage mechanisms. This non-destructive evaluation technique may operate more rapidly than ultrasonic testing while providing complementary information about material condition. The eddy current data may be incorporated into digital twin models to represent material property variations across the component.

### D. Monitoring Module

The platform 100 may include a monitoring module 140. The monitoring module 140 may include hardware and/or software configured to interface with a control system (e.g., an existing control system and/or a new control system) of the field-deployed industrial equipment. The monitoring module 140 may collect process input data from sensors and/or other instrumentation connected to the control system. As one non-limiting example, temperature data may be one type of process input data collected by the monitoring module. The monitoring module may sample and record temperature data at predetermined time intervals.

The monitoring module 140 may transmit the collected process input data to the processing unit 120 for pre-processing, storage, and/or input into the trained neural network 110. The transmission of data from the monitoring module 140 to the processing unit 120 may occur in real-time or near real-time. This may allow for substantially continuous monitoring of the industrial equipment conditions.

In some embodiments (e.g., where the processing unit 120 is not tasked with pre-processing), the monitoring module 140 may include data filtering and/or pre-processing capabilities. Noise and/or anomalous readings in the raw sensor data may be filtered out by the monitoring module before transmission to the processor. The monitoring module 140 may perform initial data formatting or normalization to prepare the process input data for use by the neural network 110.

In some embodiments, multiple monitoring modules 140 may be deployed to collect data from different locations or components of the industrial equipment. The monitoring modules 140 may be networked together to aggregate data from across the industrial equipment system. Each monitoring module 140 may have a unique identifier to associate its data with a specific location or component. In embodiments, the unique identifier may be added to each data set collected by the monitoring module.

The monitoring module 140 may include local data storage capabilities. This may allow for buffering of data in case of temporary loss of connection to the processing unit 120. The monitoring module 140 may timestamp all collected data to maintain an accurate timeline of industrial equipment conditions.

Security features may be incorporated into the monitoring module 140 to protect the integrity of the collected data. As one non-limiting example, encryption may be used for data transmission between the monitoring module 140 and the processing unit 120. As another non-limiting example, access controls may restrict which external systems can interface with the monitoring module 140.

The monitoring module 140 may be configured with alternative sensor interface architectures that support different types of process measurements beyond temperature monitoring. The module 140 may incorporate strain gauge interfaces that measure mechanical deformations in industrial equipment components during thermal cycling. The strain measurements may provide direct indication of thermal stress levels that contribute to fatigue damage accumulation. The strain data may be processed in conjunction with temperature measurements to enhance the accuracy of neural network damage predictions.

In some embodiments, the monitoring module 140 may include vibration monitoring capabilities that detect changes in equipment dynamic response characteristics as damage progresses. The vibration sensors may identify shifts in natural frequencies, damping characteristics, or mode shapes that indicate structural degradation. This modal analysis capability may provide early warning of damage development before significant temperature changes occur. The vibration data may be processed using signal processing techniques to extract features that correlate with damage states.

The monitoring module 140 may alternatively incorporate acoustic emission monitoring systems that detect stress wave signals generated by crack growth or other damage mechanisms. The acoustic emission sensors may identify the specific time and location of damage events as they occur during operation. This real-time damage detection capability may complement the predictive capabilities of the neural network by providing confirmation when predicted damage actually manifests. The acoustic emission data may be used to validate and refine neural network predictions over time.

### E. Alternative Configurations

The system 100 may be configured with alternative communication architectures that support different industrial networking protocols and topologies. The system may implement wireless mesh networking capabilities that enable monitoring modules 140 to communicate with the processing unit 120 through multi-hop wireless connections. This mesh networking approach may provide enhanced coverage and redundancy compared to point-to-point wireless links. The mesh topology may automatically reconfigure routing paths when individual communication links fail, ensuring continuous data transmission even under adverse conditions.

In alternative configurations, the system 100 may utilize edge computing architectures that distribute neural network processing across multiple local computing nodes rather than centralizing all computation in a single processing unit 120. Each edge computing node may handle neural network inference for a subset of monitoring points, reducing communication bandwidth requirements and improving system responsiveness. The edge computing approach may enhance system scalability by allowing additional computing nodes to be added as monitoring coverage expands.

The system 100 may incorporate alternative power management strategies that enable operation in remote or challenging environments where reliable electrical power may not be available. The system may utilize energy harvesting techniques that capture power from environmental sources such as thermal gradients, vibrations, or ambient light. The harvested energy may be stored in supercapacitors or rechargeable batteries to provide continuous operation during periods when environmental energy sources are insufficient. This self-powered capability may enable deployment in locations where conventional power infrastructure is not practical.

The system 100 may incorporate alternative validation and verification approaches that ensure neural network predictions remain accurate and reliable throughout the operational lifetime. The system may implement cross-validation techniques that periodically assess neural network performance using held-out datasets or synthetic test scenarios. The validation framework may detect model degradation due to concept drift, sensor calibration changes, or other factors that could compromise prediction accuracy. When validation metrics fall below acceptable thresholds, the system may trigger model retraining or recalibration procedures.

### III. Platform Operation

Embodiments of the present disclosure provide a hardware and software platform operative by a set of methods and computer-readable media comprising instructions configured to operate the aforementioned modules and computing elements in accordance with the methods. The following depicts an example of at least one method of a plurality of methods that may be performed by at least one of the aforementioned modules. Various hardware components may be used at the various stages of operations disclosed with reference to each module.

For example, although methods may be described as being performed by a single computing device, it should be understood that, in some embodiments, different operations may be performed by different networked elements in operative communication with the computing device. For example, at least one computing device 400 may be employed in the performance of some or all of the stages disclosed with regard to the methods. Similarly, an apparatus may be employed in the performance of some or all of the stages of the methods. As such, the apparatus may comprise at least those architectural components found in computing device 400.

Furthermore, although the stages of the following example method are disclosed in a particular order, it should be understood that the order is disclosed for illustrative purposes only. Stages may be combined, separated, reordered, and various intermediary stages may exist. Accordingly, it should be understood that the various stages, in various embodiments, may be performed in arrangements that differ from the ones described below. Moreover, various stages may be added or removed from the without altering or departing from the fundamental scope of the depicted methods and systems disclosed herein.

### A. Predicting Mechanical Damage From Thermal Fatigue

Consistent with embodiments of the present disclosure, a method for predicting mechanical damage from thermal fatigue in industrial equipment, (e.g., a heat exchanger, reactor, column, reboiler, and/or any other equipment with a main or supplementary function to transfer heat, change phase, and/or drive/limit a reaction) may be performed by at least one of the aforementioned modules. The method may be embodied as, for example, but not limited to, computer instructions, which, when executed, perform the method.

A machine learning model (e.g., a neural network) may be trained, producing a trained neural network. This training may allow the neural network to make predictions based on real-world data from actual industrial equipments in the field. In some embodiments, the neural network may be trained using a surrogate model having an idealized or otherwise simplified geometry. The use of the simplified geometry may help to expedite the analysis performed by the neural network after training.

In some implementations, the method may include generating a “digital twin” of a part. This may be accomplished through scans and/or ultrasonic testing of the actual part. The mechanical twin may provide a digital representation of a portion of the physical industrial equipment for analysis.

A processing unit may receive process input data from a field-deployed industrial equipment (e.g., via one or more monitoring modules). The process input data may include temperature data collected from the industrial equipment during operation. In some embodiments, the platform may monitor online processes. This monitoring may be performed through an existing control system. The online monitoring may allow for real-time collection of process data from the industrial equipment.

The processing unit may provide the process input data as input into the trained neural network. The convolutional neural network may be particularly suited for analyzing spatial data from the industrial equipment. The neural network may produce, as output, a prediction of mechanical damage to the industrial equipment. The prediction may be based on the relationship between the input data and potential mechanical damage as learned by the neural network during training. In some embodiments, the neural network may be tasked with rapidly calculating damage. This calculation may utilize a convolutional neural network trained with a surrogate model.

Real-time damage monitoring may be performed by repeating the data collection and analysis stages of the method, particularly when used in conjunction with the rapid damage calculation permitted by use of the simplified surrogate model. This ongoing monitoring may allow for continuous assessment of the industrial equipment's condition during operation.

The platform may process the prediction of mechanical damage output from the neural network. This processing may utilize a damage decision workflow. The workflow may help interpret the prediction and determine appropriate actions based on the predicted damage. In some embodiments, the platform may cause at least one of the determined appropriate actions to be performed.

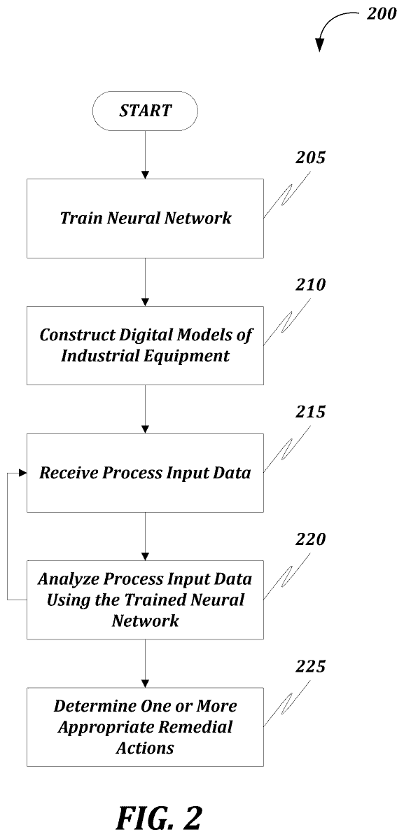

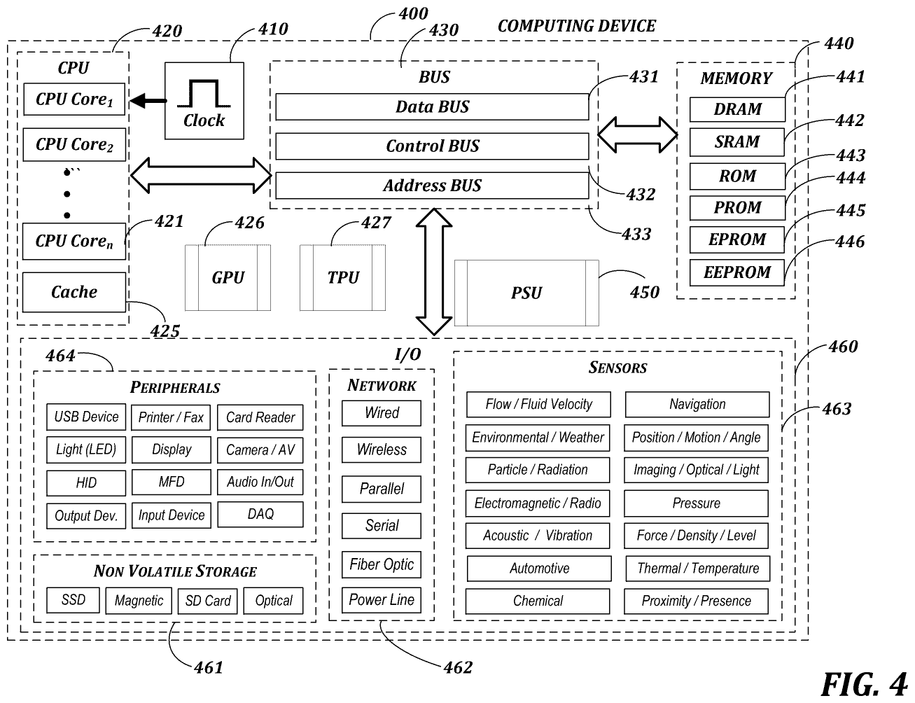

FIG. 2 is a flow chart setting forth the general stages involved in a method 200 consistent with an embodiment of the disclosure for providing the platform 100 for predicting mechanical damage from thermal fatigue. Method 200 may be implemented using a computing device 400 or any other component associated with platform 100 as described in more detail below with respect to FIG. 4. For illustrative purposes alone, computing device 400 is one potential actor in the following stages.

The method 200 may begin at stage 205, where the platform may train a machine learning model, such as a neural network. In embodiments, the neural network may be trained using an idealized geometry. This training may allow the neural network to make predictions based on real-world data from actual industrial equipments in the field. In some embodiments, the training method may include one or more of supervised learning, unsupervised learning, or semi-supervised learning. The training may include, for example, determination of a set of training data having known inputs and a known correct output. This neural network may be trained on an idealized geometry of the industrial equipment. The straining data may be divided into a learning subset and a testing subset. The neural network may be trained using the learning subset, and thereafter may be tested using the testing subset. If a threshold portion of the outputs provided by the model on the testing subset are correct (e.g., the output matches the known correct output), it may be determined that the model is adequately trained. On the other hand, if less than the threshold portion of the outputs provided by the model on the testing subset are correct (e.g., the output matches the known correct output), it may be determined that the additional training is needed.

The machine learning model may comprise a neural network, such as a convolutional neural network. In some embodiments, the convolutional neural network may be, for example, a physics-informed graph neural network (PI-GNN). The PI-GNN may combine aspects of graph neural networks (GNNs) and physics-informed neural networks (PINNs). The PI-GNN may be suited for training artificial intelligence with finite element analysis. The neural network may combine physics-informed and graph convolutional networks to predict local thermal stress. The graph convolutional network may treat the surface as a system of interrelated points forming a mesh. The physics-informed portion of the neural network may apply a real physical constraint to the solution spaces.

In some embodiments, the convolutional neural network employed in the method 200 may be configured for rapid damage prediction. The network may utilize a surrogate model to achieve this speed. The surrogate model may be a simplified representation of a complex physical system (e.g., the actual industrial equipment). This approach may allow for improved speed in assessing predicted damage without sacrificing accuracy.

The system may comprise a scanning device configured to generate a mechanical twin of a part. The scanning device may utilize various scanning techniques. These techniques may include optical scanning, laser scanning, or other three-dimensional scanning methods. The scanning device may also incorporate ultrasonic testing capabilities. Ultrasonic testing may provide additional data about the internal structure and integrity of the part.

Following training of the neural network, in stage 205, the method 200 may proceed to stage 210, where the platform may construct one or more digital models of welds within industrial equipment. The digital model may be constructed based on measurements and/or scanning results from a measuring device. The measuring device may employ optical scanning methods to obtain surface geometry data of the part. Additionally or alternatively, the measuring device may incorporate ultrasonic testing capabilities to non-destructively gather internal structural information of the part. The ultrasonic testing component of the measuring device may be capable of detecting internal flaws, such as voids or inclusions, which may not be visible through surface scanning alone. This ultrasonic capability may provide valuable information about the internal structure and quality of the part. In this way, the digital model may correspond directly to the part in the industrial equipment.

In stage 215, the platform may receive process input data. Receiving process input data may include collecting data via one or more monitoring modules. The one or more monitoring modules may include, for example a number of monitoring modules corresponding to a number of welds or parts to be monitored by the platform.

In embodiments, a monitoring module may be connected to one or more sensors configured to receive process input data related to a specific portion (e.g., a particular weld) of a field-deployed industrial equipment. As examples, the sensors may include a temperature sensor (e.g., a thermocouple), a vibration sensor, a moisture sensor, a pressure sensor, a flow rate sensor, and/or any other sensor capable of measuring a property of the associated portion of the industrial equipment. In some embodiments, the sensors may be connected directly to the monitoring module. In other embodiments, the sensors may be connected to an outside control system, which may transmit the received values to the monitoring module. The process input data may be collected at regular intervals. In some embodiments, the interval may be short enough that the data is collected substantially continuously.

The platform may preprocess the received process input data. For example, preprocessing may include (but need not be limited to) filtering of outlier values, normalization of noise data, and/or addition of additional information such as (but not limited to) a timestamp indicating a time at which the sensor data was collected and/or an identifier associated with the particular monitoring module that collected the sensor data.

In stage 220, the platform may perform an analysis of the received input process data. Performing the analysis may include providing the process input data as an input to the trained neural network. The trained neural network may then generate a prediction of mechanical damage. This prediction may be based on the analysis of the input process data. The prediction may include an assessment of the likelihood and severity of potential damage. It may also provide information about the specific locations within the industrial equipment where damage may be occurring or likely to occur.

In embodiments where the neural network is a physics informed neural network (e.g., a PINN, a PI-GNN), the output of the neural network may be limited by one or more physical constraints placed on the network. This may help to avoid outputs that do not adhere to the laws of physics.

In embodiments, stages 215 and 220 may be repeated periodically, at predetermined intervals. The intervals may be short enough to allow for real-time or substantially real-time monitoring of the field-deployed industrial equipment for predicted damage, thus allowing for preventative (rather than reactive) maintenance. In this way, the platform may be capable of performing real-time damage monitoring. The platform may substantially continuously process incoming data from the field-deployed industrial equipment. The system may analyze this data to detect patterns or anomalies that could indicate developing mechanical damage. This real-time capability may enable proactive maintenance and reduce the risk of unexpected failures. This may help to reduce downtime and/or lower aggregate operational costs of the industrial equipment and other associated equipment.

In stage 225, the platform may use the analysis of the input process data to determine and/or revise one or more appropriate actions to mitigate and/or repair the predicted damage. A damage decision workflow may be incorporated into the platform. This workflow may define a series of steps for evaluating and responding to predicted mechanical damage. For example, the prediction from the neural network may include a damage estimate as a fraction of useful life consumed. The platform may determine if the fraction exceeds a threshold damage limit, and/or if a rate of change of the damage fraction exceeds a threshold rate of change. If one or more of the thresholds are exceeded, the platform may determine one or more appropriate actions. The workflow may include one or more thresholds for different levels of damage severity. It may also specify appropriate actions to be taken based on the severity level. These actions may range from scheduling inspections to initiating emergency shutdowns. In some embodiments, the platform may automatically cause performance of at least one of the one or more appropriate actions.

As one example, where the appropriate action includes providing an alert to an operator, the platform may cause an alert to be transmitted to an operator in a human-discernible format. For example, the alert may take the form of an electronic message (e.g., an email, an SMS message, an on-screen notification, etc.), an audible message (e.g., an alarm), illumination of an indicator light, and/or the like.

As another example, where the appropriate action comprises replacement of a part, the platform may search an inventory to determine if a replacement part is on-hand. Where no replacement part is included in the inventory, the platform may cause the replacement part to be ordered from a manufacturer or retailer.

As yet another example, where heat damage to a particular portion of the industrial equipment exceeds a predetermined threshold, the platform may determine that an appropriate action is to reduce an operating temperature of at least a portion of the industrial equipment. The platform may interface with one or more control systems to cause the reduction of the operating temperature.

### B. Real-Time Assessment of Thermal Fatigue Damage

Consistent with embodiments of the present disclosure, a method for assessing damage in industrial equipment, (e.g., a heat exchanger, reactor, column, reboiler, and/or any other equipment with a main or supplementary function to transfer heat, change phase, and/or drive/limit a reaction), in real time or near-real time, may be performed by at least one of the aforementioned modules. The method may be embodied as, for example, but not limited to, computer instructions, which, when executed, perform the method.

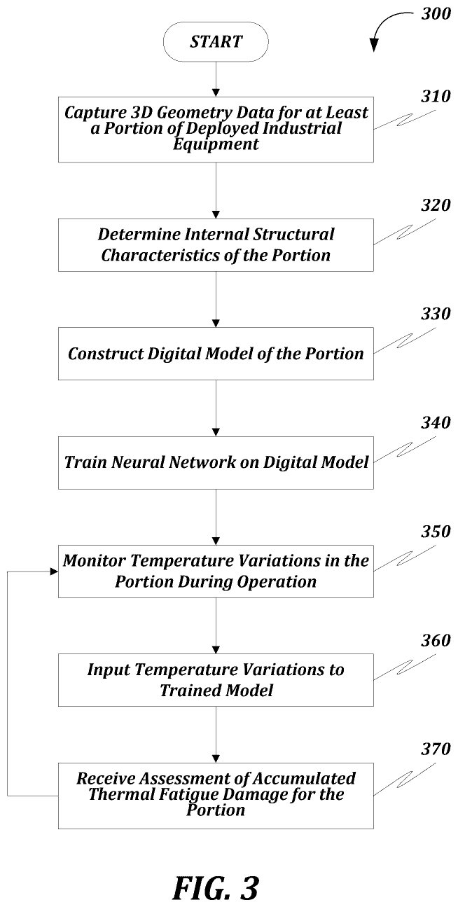

FIG. 3 is a flow chart setting forth the general stages involved in a method 300 consistent with an embodiment of the disclosure for providing the platform 100 for real-time assessment of thermal fatigue damage in industrial equipment components. Method 300 may be implemented using a computing device 400 or any other component associated with platform 100 as described in more detail below with respect to FIG. 4.

The method 300 may begin at stage 310 where the system may capture three-dimensional geometry data for at least a portion of a piece of industrial equipment using advanced scanning technologies. For example, the measuring device 130 may employ structured light scanning techniques that project calibrated patterns onto the surface of the equipment. The measuring device 130 may utilize laser triangulation methods to capture surface topology with sub-millimeter precision. The scanning process may generate point cloud data representing the external geometry of the portion of the industrial equipment, heat-affected zones, and surrounding base material regions. The measuring device 130 may perform multiple scanning passes from different angular positions to ensure complete geometric coverage of complex weld profiles. The captured three-dimensional data may be processed through mesh generation algorithms that create a coherent surface representation suitable for digital twin modeling.

The method 300 may proceed to stage 320 where the system may determine internal structural characteristics of the industrial equipment through non-destructive evaluation techniques. The measuring device 130 may employ phased array ultrasonic testing that generates cross-sectional images of the internal structure. The ultrasonic transducers may transmit high-frequency acoustic waves through the structure and analyze reflected signals to identify internal discontinuities. The measuring device 130 may detect porosity, inclusions, lack of fusion, and other manufacturing defects that may influence thermal fatigue susceptibility. The ultrasonic testing may generate volumetric data that represents material density variations and structural integrity throughout the equipment cross-section.

Stage 330 may involve constructing a comprehensive digital model of the scanned equipment by integrating the surface geometry data from stage 310 with the internal structural characteristics from stage 320. The processing unit 120 may execute data fusion algorithms that align the coordinate systems of the different measurement modalities. The digital model construction process may incorporate material property data specific to welded components, including thermal conductivity, coefficient of thermal expansion, and elastic modulus values. The processing unit 120 may generate finite element mesh structures that discretize welded joint geometry into computational elements suitable for physics-based modeling. The digital model may represent both the as-built geometry and the material property variations that result from the welding process.

The method 300 may advance to stage 340 where the neural network 110 may be trained on the digital model to learn thermal stress patterns and damage accumulation relationships. The training process may utilize finite element analysis simulations that apply various thermal cycling scenarios to the digital model. The neural network 110 may learn to correlate temperature boundary conditions with resulting stress distributions and fatigue damage rates throughout the portion of the industrial equipment. The physics-informed constraints within the neural network architecture may ensure that learned relationships satisfy fundamental thermodynamic principles such as energy conservation and thermal equilibrium. The training dataset may encompass a wide range of thermal cycling amplitudes, frequencies, and mean temperatures representative of expected field operating conditions.

Stage 350 may initiate continuous monitoring of temperature variations in the equipment during actual operation. The monitoring module 140 may interface with temperature sensors strategically positioned at critical locations on the equipment (e.g., at welded joints or other areas prone to failure). The temperature monitoring may occur at sampling rates sufficient to capture rapid thermal transients that contribute to fatigue damage accumulation. The monitoring module 140 may implement data preprocessing algorithms that filter measurement noise and compensate for sensor calibration drift. The temperature data collection may continue throughout the operational lifetime of the industrial equipment, providing a comprehensive record of thermal exposure history.

The method 300 may proceed to stage 360 where the continuously collected temperature variations may be input to the trained neural network model for real-time damage assessment. The processing unit 120 may format the temperature data into input vectors compatible with the neural network architecture. The neural network 110 may process the current temperature conditions and generate predictions of instantaneous damage rates and cumulative damage fractions. The inference process may execute rapidly enough to provide real-time feedback on equipment condition without introducing significant computational latency. The neural network 110 may account for the temporal history of temperature exposure when calculating current damage states.

Finally, stage 370 may involve receiving assessment of accumulated thermal fatigue damage from the trained neural network as the primary output of the monitoring system. The damage assessment may quantify the fraction of useful life consumed by thermal cycling exposure up to the current time. The processing unit 120 may generate confidence intervals associated with the damage predictions to quantify assessment uncertainty. The damage assessment may include spatial information identifying specific locations within the equipment (e.g., at a welded joint where damage accumulation may be most severe). The output may provide remaining useful life estimates based on projected future operating conditions and damage accumulation rates.

In some embodiments, the assessment may include calculating a damage rate and/or predicting a remaining useful life. The mathematical algorithms and methods for calculating the rate of damage accumulation and predicting remaining useful life may be implemented through a comprehensive analytical framework that processes successive damage assessments to generate accurate life predictions. The processing unit 120 may implement temporal analysis algorithms that track damage progression over time by analyzing sequences of neural network damage predictions. These algorithms may utilize time-series analysis techniques to identify patterns in damage accumulation rates and extrapolate future damage states based on historical trends.

The rate of damage accumulation calculation may be performed using finite difference methods that compute the derivative of cumulative damage with respect to time. The processing unit 120 may maintain a sliding window of recent damage assessments and apply numerical differentiation techniques to estimate the instantaneous damage rate. The finite difference approximation may be expressed mathematically as the change in damage fraction divided by the corresponding time interval between successive assessments. Higher-order finite difference schemes may be employed to improve accuracy when sufficient historical data points are available.

The extrapolation methods for remaining useful life prediction may utilize polynomial regression techniques that fit mathematical functions to historical damage progression data. The processing unit 120 may implement least squares regression algorithms that determine optimal polynomial coefficients to minimize prediction errors. Linear extrapolation may be applied when damage accumulation exhibits consistent rates over time, while quadratic or higher-order polynomial extrapolation may be used when damage rates show acceleration or deceleration trends. The extrapolation algorithms may project the fitted polynomial functions forward in time to determine when cumulative damage will reach critical failure thresholds.

Statistical models for uncertainty quantification may be integrated into the remaining life prediction algorithms to provide confidence intervals around life estimates. The processing unit 120 may implement Monte Carlo simulation techniques that account for variability in damage rate measurements and model parameter uncertainties. The statistical framework may generate probability distributions for remaining life predictions by propagating measurement uncertainties through the extrapolation calculations. Bayesian inference methods may be employed to update life predictions as new damage assessment data becomes available, incorporating prior knowledge about equipment failure patterns.

The temporal analysis techniques may include autoregressive moving average models that capture both trend and cyclical components in damage progression data. The processing unit 120 may implement ARIMA modeling algorithms that identify optimal model orders for representing damage time series. The autoregressive components may capture the influence of previous damage states on current damage rates, while moving average components may account for random fluctuations in damage measurements. Seasonal decomposition methods may be applied to separate long-term damage trends from periodic variations associated with operational cycles.

Mathematical formulations for converting successive damage assessments into life predictions may incorporate physics-based damage accumulation laws such as the Palmgren-Miner rule for fatigue damage summation. The processing unit 120 may implement algorithms that relate damage increments to stress cycle counts and material properties. The cumulative damage calculation may sum individual cycle contributions weighted by their respective damage potentials. The mathematical framework may account for load sequence effects and mean stress influences on damage accumulation rates through appropriate correction factors.

The processing unit 120 may implement Kalman filtering algorithms that provide optimal estimates of damage states and rates in the presence of measurement noise. The Kalman filter framework may model damage progression as a dynamic system with process noise representing uncertainty in damage accumulation mechanisms. The filter may recursively update damage state estimates as new neural network predictions become available, providing both filtered damage estimates and associated uncertainty bounds. Extended Kalman filtering techniques may be employed when damage progression exhibits nonlinear characteristics.

Regression analysis methods for trend identification may include robust regression techniques that minimize the influence of outlier measurements on life predictions. The processing unit 120 may implement iteratively reweighted least squares algorithms that automatically identify and downweight anomalous damage assessments. Theil-Sen regression methods may be employed to provide median-based trend estimates that are resistant to measurement errors. The regression algorithms may include automatic model selection procedures that determine optimal polynomial orders based on information criteria such as AIC or BIC.

The mathematical framework may incorporate survival analysis techniques adapted from reliability engineering to model equipment failure probabilities. The processing unit 120 may implement Weibull distribution fitting algorithms that characterize failure time distributions based on observed damage progression patterns. Hazard function calculations may provide instantaneous failure rate estimates that vary with cumulative damage levels. Survival function evaluations may generate probability estimates for equipment survival beyond specified time horizons.

Time-varying coefficient models may be implemented to account for changes in damage accumulation rates due to evolving operational conditions or material degradation. The processing unit 120 may utilize state-space modeling techniques that allow damage rate parameters to vary smoothly over time. Particle filtering algorithms may be employed for nonlinear and non-Gaussian damage progression models that cannot be handled by standard Kalman filtering approaches. The particle filter may maintain multiple hypotheses about damage states and rates, providing robust predictions under model uncertainty.

The processing unit 120 may implement spectral analysis techniques to identify periodic components in damage progression data that may be associated with operational cycles or environmental variations. Fourier transform algorithms may decompose damage time series into frequency components, enabling the identification of dominant periodicities. Wavelet analysis methods may be employed to capture time-localized frequency content in damage signals, providing insights into transient damage acceleration events.

Machine learning approaches for damage rate prediction may complement the physics-based extrapolation methods by identifying complex patterns in historical damage data. The processing unit 120 may implement recurrent neural network architectures specifically designed for time series forecasting applications. Long short-term memory networks may capture long-range dependencies in damage progression sequences, while gated recurrent units may provide computational efficiency for real-time applications. The machine learning models may be trained on historical damage progression data from similar equipment to improve prediction accuracy.

Ensemble forecasting methods may be implemented to combine predictions from multiple extrapolation algorithms and provide robust remaining life estimates. The processing unit 120 may utilize weighted averaging schemes that assign higher weights to algorithms with better historical performance. Bayesian model averaging techniques may account for model uncertainty by maintaining probability distributions over different extrapolation approaches. The ensemble framework may automatically adapt weights based on recent prediction accuracy to maintain optimal performance as conditions change.

The mathematical algorithms may incorporate adaptive learning mechanisms that continuously refine prediction models based on observed damage progression patterns. Online learning algorithms may update model parameters in real-time as new damage assessments become available. Recursive parameter estimation techniques may provide computationally efficient updates without requiring reprocessing of entire historical datasets. The adaptive framework may include change detection algorithms that identify shifts in damage accumulation patterns and trigger model recalibration procedures.

The method 300 may implement feedback mechanisms where stages 350, 360, and 370 may repeat continuously during equipment operation to provide ongoing condition monitoring. The temperature monitoring in stage 350 may operate as a background process that maintains a continuous data stream for neural network processing. The damage assessment updates may occur at intervals appropriate for the specific application requirements and equipment criticality levels. The method may generate automated alerts when damage levels exceed predetermined threshold values, enabling proactive maintenance scheduling before equipment failure occurs.

### IV. Computer Architecture

Embodiments of the present disclosure provide a hardware and software platform operative as a distributed system of modules and computing elements.

Platform 100 may be embodied as, for example, but not be limited to, a website, a web application, a desktop application, a backend application, and a mobile application compatible with a computing device 400. The computing device 400 may comprise, but not be limited to, the following:
Mobile computing device, such as, but is not limited to, a laptop, a tablet, a smartphone, a drone, a wearable, an embedded device, a handheld device, an Arduino, an industrial device, or a remotely operable recording device;
A supercomputer, an exascale supercomputer, a mainframe, or a quantum computer;
A minicomputer, wherein the minicomputer computing device comprises, but is not limited to, an IBM AS400/iSeries/System I, A DEC VAX/PDP, an HP3000, a Honeywell-Bull DPS, a Texas Instruments TI-990, or a Wang Laboratories VS Series;
A microcomputer, wherein the microcomputer computing device comprises, but is not limited to, a server, wherein a server may be rack-mounted, a workstation, an industrial device, a raspberry pi, a desktop, or an embedded device;

Platform 100 may be hosted on a centralized server or a cloud computing service. Although method 200 has been described to be performed by a computing device 400, it should be understood that, in some embodiments, different operations may be performed by a plurality of the computing devices 400 in operative communication on at least one network.

Embodiments of the present disclosure may comprise a system having a central processing unit (CPU) 420, a bus 430, a memory unit 440, a power supply unit (PSU) 450, and one or more Input/Output (I/O) units. The CPU 420 coupled to the memory unit 440 and the plurality of I/O units 460 via the bus 430, all of which are powered by the PSU 450. It should be understood that, in some embodiments, each disclosed unit may actually be a plurality of such units for redundancy, high availability, and/or performance purposes. The combination of the presently disclosed units is configured to perform the stages of any method disclosed herein.

FIG. 4 is a block diagram of a system including computing device 400. Consistent with an embodiment of the disclosure, the aforementioned CPU 420, the bus 430, the memory unit 440, a PSU 450, and the plurality of I/O units 460 may be implemented in a computing device, such as computing device 400 of FIG. 4. Any suitable combination of hardware, software, or firmware may be used to implement the aforementioned units. For example, the CPU 420, the bus 430, and the memory unit 440 may be implemented with computing device 400 or any of other computing devices 400, in combination with computing device 400. The aforementioned system, device, and components are examples and other systems, devices, and components may comprise the aforementioned CPU 420, the bus 430, and the memory unit 440, consistent with embodiments of the disclosure.

At least one computing device 400 may be embodied as any of the computing elements illustrated in all of the attached figures. A computing device 400 does not need to be electronic, nor even have a CPU 420, nor bus 430, nor memory unit 440. The definition of the computing device 400 to a person having ordinary skill in the art is “A device that computes, especially a programmable [usually] electronic machine that performs high-speed mathematical or logical operations or that assembles, stores, correlates, or otherwise processes information.” Any device which processes information qualifies as a computing device 400, especially if the processing is purposeful.

With reference to FIG. 4, a system consistent with an embodiment of the disclosure may include a computing device, such as computing device 400. In some configurations, the computing device 400 may include at least one clock module 410, at least one CPU 420, at least one bus 430, and at least one memory unit 440, at least one PSU 450, and at least one I/O 460 module, wherein I/O module may be comprised of, but not limited to a non-volatile storage sub-module 461, a communication sub-module 462, a sensors sub-module 463, and a peripherals sub-module 464.

In a system consistent with an embodiment of the disclosure, the computing device 400 may include the clock module 410, known to a person having ordinary skill in the art as a clock generator, which produces clock signals. Clock signals may oscillate between a high state and a low state at a controllable rate, and may be used to synchronize or coordinate actions of digital circuits. Most integrated circuits (ICs) of sufficient complexity use a clock signal in order to synchronize different parts of the circuit, cycling at a rate slower than the worst-case internal propagation delays. One well-known example of the aforementioned integrated circuit is the CPU 420, the central component of modern computers, which relies on a clock signal. The clock 410 can comprise a plurality of embodiments, such as, but not limited to, a single-phase clock which transmits all clock signals on effectively 1 wire, a two-phase clock which distributes clock signals on two wires, each with non-overlapping pulses, and a four-phase clock which distributes clock signals on 4 wires.

Many computing devices 400 may use a “clock multiplier” which multiplies a lower frequency external clock to the appropriate clock rate of the CPU 420. This allows the CPU 420 to operate at a much higher frequency than the rest of the computing device 400, which affords performance gains in situations where the CPU 420 does not need to wait on an external factor (like memory 440 or input/output 460). Some embodiments of the clock 410 may include dynamic frequency change, where the time between clock edges can vary widely from one edge to the next and back again.

In a system consistent with an embodiment of the disclosure, the computing device 400 may include the CPU 420 comprising at least one CPU Core 421. In other embodiments, the CPU 420 may include a plurality of identical CPU cores 421, such as, but not limited to, homogeneous multi-core systems. It is also possible for the plurality of CPU cores 421 to comprise different CPU cores 421, such as, but not limited to, heterogeneous multi-core systems, big. LITTLE systems and some AMD accelerated processing units (APU). The CPU 420 reads and executes program instructions which may be used across many application domains, for example, but not limited to, general purpose computing, embedded computing, network computing, digital signal processing (DSP), and graphics processing (GPU). The CPU 420 may run multiple instructions on separate CPU cores 421 simultaneously. The CPU 420 may be integrated into at least one of a single integrated circuit die, and multiple dies in a single chip package. The single integrated circuit die and/or the multiple dies in a single chip package may contain a plurality of other elements of the computing device 400, for example, but not limited to, the clock 410, the bus 430, the memory 440, and I/O 460.

The CPU 420 may contain cache 422 such as but not limited to a level 1 cache, a level 2 cache, a level 3 cache, or combinations thereof. The cache 422 may or may not be shared amongst a plurality of CPU cores 421. The cache 422 sharing may comprise at least one of message passing and inter-core communication methods used for the at least one CPU Core 421 to communicate with the cache 422. The inter-core communication methods may comprise, but not be limited to, bus, ring, two-dimensional mesh, and crossbar. The aforementioned CPU 420 may employ symmetric multiprocessing (SMP) design.

The one or more CPU cores 421 may comprise soft microprocessor cores on a single field programmable gate array (FPGA), such as semiconductor intellectual property cores (IP Core). The architectures of the one or more CPU cores 421 may be based on at least one of, but not limited to, Complex Instruction Set Computing (CISC), Zero Instruction Set Computing (ZISC), and Reduced Instruction Set Computing (RISC). At least one performance-enhancing method may be employed by one or more of the CPU cores 421, for example, but not limited to Instruction-level parallelism (ILP) such as, but not limited to, superscalar pipelining, and Thread-level parallelism (TLP).

In a system consistent with an embodiment of the disclosure, the computing device 400 may include a graphics processing unit (GPU) 426. The GPU 426 that may provide specialized computational capabilities particularly suited for artificial intelligence processing tasks. The GPU 426 may comprise multiple parallel processing cores that may enable simultaneous execution of numerous mathematical operations required for neural network inference. The parallel architecture of the GPU 426 may be particularly advantageous for processing the matrix operations and convolution calculations that form the computational foundation of the physics-informed graph neural network 110. The GPU 426 may accelerate the training process of neural networks by distributing computational workload across hundreds or thousands of processing cores, significantly reducing the time required to develop accurate damage prediction models. The artificial intelligence processing capabilities of the GPU 426 may enable real-time inference operations where temperature data from multiple monitoring points may be processed simultaneously to generate comprehensive damage assessments across entire industrial equipment systems.

The computing device 400 may include a tensor processing unit (TPU) 427 that may be specifically designed to accelerate artificial intelligence processing workloads. The TPU 427 may provide specialized hardware acceleration for the neural network 110 operations, particularly for the physics-informed graph neural network computations that form the core of the damage prediction system. The TPU 427 may implement dedicated matrix multiplication units and specialized memory architectures that may be optimized for the tensor operations commonly used in neural network inference. The TPU 427 may enable significantly faster processing of the graph convolutional operations and physics-informed constraint evaluations compared to general-purpose CPU processing. The TPU 427 may support parallel processing of multiple temperature measurement inputs simultaneously, allowing the system to handle complex industrial equipment geometries with numerous monitoring points without introducing computational latency that could compromise real-time damage assessment capabilities.

Consistent with the embodiments of the present disclosure, the aforementioned computing device 400 may employ a communication system that transfers data between components inside the computing device 400, and/or the plurality of computing devices 400. The aforementioned communication system will be known to a person having ordinary skill in the art as a bus 430. The bus 430 may embody internal and/or external hardware and software components, for example, but not limited to a wire, an optical fiber, various communication protocols, and/or any physical arrangement that provides the same logical function as a parallel electrical bus. The bus 430 may comprise at least one of a parallel bus, wherein the parallel bus carries data words in parallel on multiple wires; and a serial bus, wherein the serial bus carries data in bit-wise serial form. The bus 430 may embody a plurality of topologies, for example, but not limited to, a multidrop/electrical parallel topology, a daisy chain topology, and connected by switched hubs, such as a USB bus. The bus 430 may comprise a plurality of embodiments, for example, but not limited to:
Internal data bus (data bus) 431/Memory bus
Control bus 432
Address bus 433
System Management Bus (SMBus)
Front-Side-Bus (FSB)
External Bus Interface (EBI)
Local bus
Expansion bus
Lightning bus
Controller Area Network (CAN bus)
Camera Link
ExpressCard
Advanced Technology management Attachment (ATA), including embodiments and derivatives such as, but not limited to, Integrated Drive Electronics (IDE)/Enhanced IDE (EIDE), ATA Packet Interface (ATAPI), Ultra-Direct Memory Access (UDMA), Ultra ATA (UATA)/Parallel ATA (PATA)/Serial ATA (SATA), CompactFlash (CF) interface, Consumer Electronics ATA (CE-ATA)/Fiber Attached Technology Adapted (FATA), Advanced Host Controller Interface (AHCI), SATA Express (SATAe)/External SATA (eSATA), including the powered embodiment eSATAp/Mini-SATA (mSATA), and Next Generation Form Factor (NGFF)/M.2.
Small Computer System Interface (SCSI)/Serial Attached SCSI (SAS)
HyperTransport
InfiniBand
RapidIO
Mobile Industry Processor Interface (MIPI)
Coherent Processor Interface (CAPI)
Plug-n-play
1-Wire
Peripheral Component Interconnect (PCI), including embodiments such as but not limited to, Accelerated Graphics Port (AGP), Peripheral Component Interconnect eXtended (PCI-X), Peripheral Component Interconnect Express (PCI-e) (e.g., PCI Express Mini Card, PCI Express M.2 [Mini PCIe v2], PCI Express External Cabling [ePCIe], and PCI Express OCuLink [Optical Copper{Cu} Link]), Express Card, AdvancedTCA, AMC, Universal IO, Thunderbolt/Mini DisplayPort, Mobile PCIe (M-PCIe), U.2, and Non-Volatile Memory Express (NVMe)/Non-Volatile Memory Host Controller Interface Specification (NVMHCIS).
Industry Standard Architecture (ISA), including embodiments such as, but not limited to Extended ISA (EISA), PC/XT-bus/PC/AT-bus/PC/104 bus (e.g., PC/104-Plus, PCI/104-Express, PCI/104, and PCI-104), and Low Pin Count (LPC).
Music Instrument Digital Interface (MIDI)
Universal Serial Bus (USB), including embodiments such as, but not limited to, Media Transfer Protocol (MTP)/Mobile High-Definition Link (MHL), Device Firmware Upgrade (DFU), wireless USB, InterChip USB, IEEE 1394 Interface/Firewire, Thunderbolt, and eXtensible Host Controller Interface (xHCI).

Consistent with the embodiments of the present disclosure, the aforementioned computing device 400 may employ hardware integrated circuits that store information for immediate use in the computing device 400, known to persons having ordinary skill in the art as primary storage or memory 440. The memory 440 operates at high speed, distinguishing it from the non-volatile storage sub-module 461, which may be referred to as secondary or tertiary storage, which provides relatively slower-access to information but offers higher storage capacity. The data contained in memory 440, may be transferred to secondary storage via techniques such as, but not limited to, virtual memory and swap. The memory 440 may be associated with addressable semiconductor memory, such as integrated circuits consisting of silicon-based transistors, that may be used as primary storage or for other purposes in the computing device 400. The memory 440 may comprise a plurality of embodiments, such as, but not limited to volatile memory, non-volatile memory, and semi-volatile memory. It should be understood by a person having ordinary skill in the art that the following are non-limiting examples of the aforementioned memory:
Volatile memory, which requires power to maintain stored information, for example, but not limited to, Dynamic Random-Access Memory (DRAM) 441, Static Random-Access Memory (SRAM) 442, CPU Cache memory 425, Advanced Random-Access Memory (A-RAM), and other types of primary storage such as Random-Access Memory (RAM).
Non-volatile memory, which can retain stored information even after power is removed, for example, but not limited to, Read-Only Memory (ROM) 443, Programmable ROM (PROM) 444, Erasable PROM (EPROM) 445, Electrically Erasable PROM (EEPROM) 446 (e.g., flash memory and Electrically Alterable PROM [EAPROM]), Mask ROM (MROM), One Time Programmable (OTP) ROM/Write Once Read Many (WORM), Ferroelectric RAM (FeRAM), Parallel Random-Access Machine (PRAM), Split-Transfer Torque RAM (STT-RAM), Silicon Oxime Nitride Oxide Silicon (SONOS), Resistive RAM (RRAM), Nano RAM (NRAM), 3D XPoint, Domain-Wall Memory (DWM), and millipede memory.
Semi-volatile memory may have limited non-volatile duration after power is removed but may lose data after said duration has passed. Semi-volatile memory provides high performance, durability, and other valuable characteristics typically associated with volatile memory, while providing some benefits of true non-volatile memory. The semi-volatile memory may comprise volatile and non-volatile memory, and/or volatile memory with a battery to provide power after power is removed. The semi-volatile memory may comprise, but is not limited to, spin-transfer torque RAM (STT-RAM).

Consistent with the embodiments of the present disclosure, the aforementioned computing device 400 may employ a communication system between an information processing system, such as the computing device 400, and the outside world, for example, but not limited to, human, environment, and another computing device 400. The aforementioned communication system may be known to a person having ordinary skill in the art as an Input/Output (I/O) module 460. The I/O module 460 regulates a plurality of inputs and outputs with regard to the computing device 400, wherein the inputs are a plurality of signals and data received by the computing device 400, and the outputs are the plurality of signals and data sent from the computing device 400. The I/O module 460 interfaces with a plurality of hardware, such as, but not limited to, non-volatile storage 461, communication devices 462, sensors 463, and peripherals 464. The plurality of hardware is used by at least one of, but not limited to, humans, the environment, and another computing device 400 to communicate with the present computing device 400. The I/O module 460 may comprise a plurality of forms, for example, but not limited to channel I/O, port mapped I/O, asynchronous I/O, and Direct Memory Access (DMA).

Consistent with the embodiments of the present disclosure, the aforementioned computing device 400 may employ a non-volatile storage sub-module 461, which may be referred to by a person having ordinary skill in the art as one of secondary storage, external memory, tertiary storage, off-line storage, and auxiliary storage. The non-volatile storage sub-module 461 may not be accessed directly by the CPU 420 without using an intermediate area in the memory 440. The non-volatile storage sub-module 461 may not lose data when power is removed and may be orders of magnitude less costly than storage used in memory 440. Further, the non-volatile storage sub-module 461 may have a slower speed and higher latency than in other areas of the computing device 400. The non-volatile storage sub-module 461 may comprise a plurality of forms, such as, but not limited to, Direct Attached Storage (DAS), Network Attached Storage (NAS), Storage Area Network (SAN), nearline storage, Massive Array of Idle Disks (MAID), Redundant Array of Independent Disks (RAID), device mirroring, off-line storage, and robotic storage. The non-volatile storage sub-module (461) may comprise a plurality of embodiments, such as, but not limited to:
Optical storage, for example, but not limited to, Compact Disk (CD) (CD-ROM/CD-R/CD-RW), Digital Versatile Disk (DVD) (DVD-ROM/DVD-R/DVD+R/DVD-RW/DVD+RW/DVD±RW/DVD+R DL/DVD-RAM/HD-DVD), Blu-ray Disk (BD) (BD-ROM/BD-R/BD-RE/BD-R DL/BD-RE DL), and Ultra-Density Optical (UDO).
Semiconductor storage, for example, but not limited to, flash memory, such as, but not limited to, USB flash drive, Memory card, Subscriber Identity Module (SIM) card, Secure Digital (SD) card, Smart Card, CompactFlash (CF) card, Solid-State Drive (SSD) and memristor.
Magnetic storage such as, but not limited to, Hard Disk Drive (HDD), tape drive, carousel memory, and Card Random-Access Memory (CRAM).
Phase-change memory
Holographic data storage such as Holographic Versatile Disk (HVD).
Molecular Memory
Deoxyribonucleic Acid (DNA) digital data storage

Consistent with the embodiments of the present disclosure, the computing device 400 may employ a communication sub-module 462 as a subset of the I/O module 460, which may be referred to by a person having ordinary skill in the art as at least one of, but not limited to, a computer network, a data network, and a network. The network may allow computing devices 400 to exchange data using connections, which may also be known to a person having ordinary skill in the art as data links, which may include data links between network nodes. The nodes may comprise networked computer devices 400 that may be configured to originate, route, and/or terminate data. The nodes may be identified by network addresses and may include a plurality of hosts consistent with the embodiments of a computing device 400. Examples of computing devices that may include a communication sub-module 462 include, but are not limited to, personal computers, phones, servers, drones, and networking devices such as, but not limited to, hubs, switches, routers, modems, and firewalls.

Two nodes can be considered networked together when one computing device 400 can exchange information with the other computing device 400, regardless of any direct connection between the two computing devices 400. The communication sub-module 462 supports a plurality of applications and services, such as, but not limited to World Wide Web (WWW), digital video and audio, shared use of application and storage computing devices 400, printers/scanners/fax machines, email/online chat/instant messaging, remote control, distributed computing, etc. The network may comprise one or more transmission mediums, such as, but not limited to conductive wire, fiber optics, and wireless signals. The network may comprise one or more communications protocols to organize network traffic, wherein application-specific communications protocols may be layered, and may be known to a person having ordinary skill in the art as being improved for carrying a specific type of payload, when compared with other more general communications protocols. The plurality of communications protocols may comprise, but are not limited to, IEEE 802, ethernet, Wireless LAN (WLAN/Wi-Fi), Internet Protocol (IP) suite (e.g., TCP/IP, UDP, Internet Protocol version 4 [IPv4], and Internet Protocol version 6 [IPv6]), Synchronous Optical Networking (SONET)/Synchronous Digital Hierarchy (SDH), Asynchronous Transfer Mode (ATM), and cellular standards (e.g., Global System for Mobile Communications [GSM], General Packet Radio Service [GPRS], Code-Division Multiple Access [CDMA], Integrated Digital Enhanced Network [IDEN], Long Term Evolution [LTE], LTE-Advanced [LTE-A], and fifth generation [5G] communication protocols).

The communication sub-module 462 may comprise a plurality of size, topology, traffic control mechanisms and organizational intent policies. The communication sub-module 462 may comprise a plurality of embodiments, such as, but not limited to:
Wired communications, such as, but not limited to, coaxial cable, phone lines, twisted pair cables (ethernet), and InfiniBand.
Wireless communications, such as, but not limited to, communications satellites, cellular systems, radio frequency/spread spectrum technologies, IEEE 802.11 Wi-Fi, Bluetooth, NFC, free-space optical communications, terrestrial microwave, and Infrared (IR) communications. Wherein cellular systems embody technologies such as, but not limited to, 3G, 4G (such as WiMAX and LTE), and 5G (short and long wavelength).
Parallel communications, such as, but not limited to, LPT ports.
Serial communications, such as, but not limited to, RS-232 and USB.
Fiber Optic communications, such as, but not limited to, Single-mode optical fiber (SMF) and Multi-mode optical fiber (MMF).
Power Line communications

The aforementioned network may comprise a plurality of layouts, such as, but not limited to, bus networks such as Ethernet, star networks such as Wi-Fi, ring networks, mesh networks, fully connected networks, and tree networks. The network can be characterized by its physical capacity or its organizational purpose. Use of the network, including user authorization and access rights, may differ according to the layout of the network. The characterization may include, but is not limited to a nanoscale network, a Personal Area Network (PAN), a Local Area Network (LAN), a Home Area Network (HAN), a Storage Area Network (SAN), a Campus Area Network (CAN), a backbone network, a Metropolitan Area Network (MAN), a Wide Area Network (WAN), an enterprise private network, a Virtual Private Network (VPN), and a Global Area Network (GAN).

Consistent with the embodiments of the present disclosure, the aforementioned computing device 400 may employ a sensors sub-module 463 as a subset of the I/O 460. The sensors sub-module 463 comprises at least one of the device, module, or subsystem whose purpose is to detect events or changes in its environment and send the information to the computing device 400. Sensors may be sensitive to the property they are configured to measure, may not be sensitive to any property not measured but be encountered in its application, and may not significantly influence the measured property. The sensors sub-module 463 may comprise a plurality of digital devices and analog devices, wherein if an analog device is used, an Analog to Digital (A-to-D) converter must be employed to interface the said device with the computing device 400. The sensors may be subject to a plurality of deviations that limit sensor accuracy. The sensors sub-module 463 may comprise a plurality of embodiments, such as, but not limited to, chemical sensors, automotive sensors, acoustic/sound/vibration sensors, electric current/electric potential/magnetic/radio sensors, environmental/weather/moisture/humidity sensors, flow/fluid velocity sensors, ionizing radiation/particle sensors, navigation sensors, position/angle/displacement/distance/speed/acceleration sensors, imaging/optical/light sensors, pressure sensors, force/density/level sensors, thermal/temperature sensors, and proximity/presence sensors. It should be understood by a person having ordinary skill in the art that the ensuing are non-limiting examples of the aforementioned sensors:
Chemical sensors, such as, but not limited to, breathalyzer, carbon dioxide sensor, carbon monoxide/smoke detector, catalytic bead sensor, chemical field-effect transistor, chemiresistor, electrochemical gas sensor, electronic nose, electrolyte-insulator-semiconductor sensor, energy-dispersive X-ray spectroscopy, fluorescent chloride sensors, holographic sensor, hydrocarbon dew point analyzer, hydrogen sensor, hydrogen sulfide sensor, infrared point sensor, ion-selective electrode, nondispersive infrared sensor, microwave chemistry sensor, nitrogen oxide sensor, olfactometer, optode, oxygen sensor, ozone monitor, pellistor, pH glass electrode, potentiometric sensor, redox electrode, zinc oxide nanorod sensor, and biosensors (such as nanosensors).
Automotive sensors, such as, but not limited to, air flow meter/mass airflow sensor, air-fuel ratio meter, AFR sensor, blind spot monitor, engine coolant/exhaust gas/cylinder head/transmission fluid temperature sensor, hall effect sensor, wheel/automatic transmission/turbine/vehicle speed sensor, airbag sensors, brake fluid/engine crankcase/fuel/oil/tire pressure sensor, camshaft/crankshaft/throttle position sensor, fuel/oil level sensor, knock sensor, light sensor, MAP sensor, oxygen sensor (o2), parking sensor, radar sensor, torque sensor, variable reluctance sensor, and water-in-fuel sensor.
Acoustic, sound and vibration sensors, such as, but not limited to, microphone, lace sensors such as a guitar pickup, seismometer, sound locator, geophone, and hydrophone.
Electric current, electric potential, magnetic, and radio sensors, such as, but not limited to, current sensor, Daly detector, electroscope, electron multiplier, faraday cup, galvanometer, hall effect sensor, hall probe, magnetic anomaly detector, magnetometer, magnetoresistance, MEMS magnetic field sensor, metal detector, planar hall sensor, radio direction finder, and voltage detector.
Environmental, weather, moisture, and humidity sensors, such as, but not limited to, actinometer, air pollution sensor, moisture alarm, ceilometer, dew warning, electrochemical gas sensor, fish counter, frequency domain sensor, gas detector, hook gauge evaporimeter, humistor, hygrometer, leaf sensor, lysimeter, pyranometer, pyrgeometer, psychrometer, rain gauge, rain sensor, seismometers, SNOTEL, snow gauge, soil moisture sensor, stream gauge, and tide gauge.
Flow and fluid velocity sensors, such as, but not limited to, air flow meter, anemometer, flow sensor, gas meter, mass flow sensor, and water meter.
Ionizing radiation and particle sensors, such as, but not limited to, cloud chamber, Geiger counter, Geiger-Muller tube, ionization chamber, neutron detection, proportional counter, scintillation counter, semiconductor detector, and thermoluminescent dosimeter.
Navigation sensors, such as, but not limited to, airspeed indicator, altimeter, attitude indicator, depth gauge, fluxgate compass, gyroscope, inertial navigation system, inertial reference unit, magnetic compass, MHD sensor, ring laser gyroscope, turn coordinator, variometer, vibrating structure gyroscope, and yaw rate sensor.
Position, angle, displacement, distance, speed, and acceleration sensors, such as but not limited to, accelerometer, displacement sensor, flex sensor, free-fall sensor, gravimeter, impact sensor, laser rangefinder, LIDAR, odometer, photoelectric sensor, position sensor such as, but not limited to, GPS or Glonass, angular rate sensor, shock detector, ultrasonic sensor, tilt sensor, tachometer, ultra-wideband radar, variable reluctance sensor, and velocity receiver.
Imaging, optical and light sensors, such as, but not limited to, CMOS sensor, colorimeter, contact image sensor, electro-optical sensor, infra-red sensor, kinetic inductance detector, LED configured as a light sensor, light-addressable potentiometric sensor, Nichols radiometer, fiber-optic sensors, optical position sensor, thermopile laser sensor, photodetector, photodiode, photomultiplier tubes, phototransistor, photoelectric sensor, photoionization detector, photomultiplier, photoresistor, photoswitch, phototube, scintillometer, Shack-Hartmann, single-photon avalanche diode, superconducting nanowire single-photon detector, transition edge sensor, visible light photon counter, and wavefront sensor.
Pressure sensors, such as, but not limited to, barograph, barometer, boost gauge, bourdon gauge, hot filament ionization gauge, ionization gauge, McLeod gauge, Oscillating U-tube, permanent downhole gauge, piezometer, Pirani gauge, pressure sensor, pressure gauge, tactile sensor, and time pressure gauge.
Force, Density, and Level sensors, such as, but not limited to, bhangmeter, hydrometer, force gauge or force sensor, level sensor, load cell, magnetic level or nuclear density sensor or strain gauge, piezocapacitive pressure sensor, piezoelectric sensor, torque sensor, and viscometer.
Thermal and temperature sensors, such as, but not limited to, bolometer, bimetallic strip, calorimeter, exhaust gas temperature gauge, flame detection/pyrometer, Gardon gauge, Golay cell, heat flux sensor, microbolometer, microwave radiometer, net radiometer, infrared/quartz/resistance thermometer, silicon bandgap temperature sensor, thermistor, and thermocouple.
Proximity and presence sensors, such as, but not limited to, alarm sensor, doppler radar, motion detector, occupancy sensor, proximity sensor, passive infrared sensor, reed switch, stud finder, triangulation sensor, touch switch, and wired glove.

Consistent with the embodiments of the present disclosure, the aforementioned computing device 400 may employ a peripherals sub-module 464 as a subset of the I/O 460. The peripheral sub-module 464 comprises ancillary devices uses to put information into and get information out of the computing device 400. There are 3 categories of devices comprising the peripheral sub-module 464, which exist based on their relationship with the computing device 400, input devices, output devices, and input/output devices. Input devices send at least one of data and instructions to the computing device 400. Input devices can be categorized based on, but not limited to:
Modality of input, such as, but not limited to, mechanical motion, audio, visual, and tactile.
Whether the input is discrete, such as but not limited to, pressing a key, or continuous such as, but not limited to the position of a mouse.
The number of degrees of freedom involved, such as, but not limited to, two-dimensional mice and three-dimensional mice used for Computer-Aided Design (CAD) applications.

Output devices provide output from the computing device 400. Output devices convert electronically generated information into a form that can be presented to humans. Input/output devices perform that perform both input and output functions. It should be understood by a person having ordinary skill in the art that the ensuing are non-limiting embodiments of the aforementioned peripheral sub-module 464:
Input Devices
   Human Interface Devices (HID), such as, but not limited to, pointing device (e.g., mouse, touchpad, joystick, touchscreen, game controller/gamepad, remote, light pen, light gun, infrared remote, jog dial, shuttle, and knob), keyboard, graphics tablet, digital pen, gesture recognition devices, magnetic ink character recognition, Sip-and-Puff (SNP) device, and Language Acquisition Device (LAD).
   High degree of freedom devices, that require up to six degrees of freedom such as, but not limited to, camera gimbals, Cave Automatic Virtual Environment (CAVE), and virtual reality systems.
   Video Input devices are used to digitize images or video from the outside world into the computing device 400. The information can be stored in a multitude of formats depending on the user's requirement. Examples of types of video input devices include, but are not limited to, digital camera, digital camcorder, portable media player, webcam, Microsoft Kinect, image scanner, fingerprint scanner, barcode reader, 3D scanner, laser rangefinder, eye gaze tracker, computed tomography, magnetic resonance imaging, positron emission tomography, medical ultrasonography, TV tuner, and iris scanner.
   Audio input devices are used to capture sound. In some cases, an audio output device can be used as an input device to capture produced sound. Audio input devices allow a user to send audio signals to the computing device 400 for at least one of processing, recording, and carrying out commands. Devices such as microphones allow users to speak to the computer to record a voice message or navigate software. Aside from recording, audio input devices are also used with speech recognition software. Examples of types of audio input devices include, but not limited to microphone, Musical Instrumental Digital Interface (MIDI) devices such as, but not limited to a keyboard, and headset.
   Data AcQuisition (DAQ) devices convert at least one of analog signals and physical parameters to digital values for processing by the computing device 400. Examples of DAQ devices may include, but not limited to, Analog to Digital Converter (ADC), data logger, signal conditioning circuitry, multiplexer, and Time to Digital Converter (TDC).
Output Devices may further comprise, but not be limited to:
   Display devices may convert electrical information into visual form, such as, but not limited to, monitor, TV, projector, and Computer Output Microfilm (COM). Display devices can use a plurality of underlying technologies, such as, but not limited to, Cathode-Ray Tube (CRT), Thin-Film Transistor (TFT), Liquid Crystal Display (LCD), Organic Light-Emitting Diode (OLED), MicroLED, E Ink Display (ePaper) and Refreshable Braille Display (Braille Terminal).
   Printers, such as, but not limited to, inkjet printers, laser printers, 3D printers, solid ink printers, and plotters.
   Audio and Video (AV) devices, such as, but not limited to, speakers, headphones, amplifiers, and lights, which include lamps, strobes, DJ lighting, stage lighting, architectural lighting, special effect lighting, and lasers.
   Other devices such as Digital to Analog Converter (DAC)
Input/Output Devices may further comprise, but not be limited to, touchscreens, networking devices (e.g., devices disclosed in network sub-module 462), data storage devices (non-volatile storage 461), facsimile (FAX), and graphics/sound cards.

All rights, including copyrights in the code included herein, are vested in and the property of the Applicant. The Applicant retains and reserves all rights in the code included herein, and grants permission to reproduce the material only in connection with the reproduction of the granted patent and for no other purpose.

### V. Claims

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as examples for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved.

Although very narrow claims are presented herein, it should be recognized that the scope of this disclosure is much broader than presented by the claims. It is intended that broader claims will be submitted in an application that claims the benefit of priority from this application.

1. A method for predicting mechanical damage from thermal fatigue, the method comprising:
training a physics-informed graph neural network to predict mechanical damage to at least a portion of a field-deployed industrial equipment, wherein the neural network is trained based on an idealized geometry of the field-deployed industrial equipment;
receiving, by a processor, process input data from the field-deployed industrial equipment;
inputting, by the processor, the process input data including at least temperature data into the trained neural network; and
generating, by the processor using the trained neural network, a prediction of mechanical damage based on the process input data.

2. The method of claim 1, further comprising:
generating a digital twin of the at least a portion of the field-deployed industrial equipment through scans and ultrasonic testing.

3. The method of claim 1, further comprising:
monitoring online processes through an existing control system to collect the process input data.

4. The method of claim 1, wherein the neural network comprises a convolutional neural network.

5. The method of claim 4, further comprising:
rapidly calculating damage using the convolutional neural network and a surrogate model, wherein the surrogate model comprises a simplified representation of the field-deployed industrial equipment.

6. The method of claim 1, further comprising:
repeating the steps of receiving, inputting, and generating at predefined intervals to perform substantially real-time damage monitoring.

7. The method of claim 1, further comprising:
processing the prediction of mechanical damage using a damage decision workflow to determine one or more appropriate actions to be performed based on the damage prediction; and
causing performance of at least one of the one or more appropriate actions.

8. A system for predicting mechanical damage from thermal fatigue in industrial equipment, the system comprising:
a physics-informed graph neural network trained to predict mechanical damage to at least a portion of a field-deployed industrial equipment, wherein the neural network is trained based on an idealized geometry of the field-deployed industrial equipment;
a processor configured to:
receive process input data from the field-deployed industrial equipment;
input the process input data into the trained neural network; and
generate, using the trained neural network, a prediction of mechanical damage based on the process input data.

9. The system of claim 8, wherein the process input data comprises temperature data collected from the field-deployed industrial equipment during operation.

10. The system of claim 8, further comprising:
a scanning device configured to generate a digital twin of at least a portion of the field-deployed industrial equipment through scanning and ultrasonic testing of the industrial equipment.

11. The system of claim 8, further comprising:
a monitoring module configured to monitor online processes through an existing control system to collect the process input data from the field-deployed industrial equipment.

12. The system of claim 8, wherein the physics-informed graph neural network comprises a convolutional neural network configured to rapidly calculate damage using a surrogate model based on the idealized geometry.

13. The system of claim 8, wherein the processor is further configured to repeat the receiving, inputting, and generating at predefined intervals to perform real-time damage monitoring of the field-deployed industrial equipment.

14. The system of claim 8, wherein the processor is further configured to:
process the prediction of mechanical damage using a damage decision workflow to determine one or more appropriate actions to be performed based on the prediction of mechanical damage; and
cause performance of at least one of the one or more appropriate actions.

15. A method for real-time assessment of thermal fatigue damage in industrial equipment components, the method comprising:
capturing three-dimensional geometry data of at least a portion of field-deployed industrial equipment using a scanning device;
performing ultrasonic testing of the portion to detect internal structural characteristics;
constructing a digital twin model of the portion based on the three-dimensional geometry data and ultrasonic testing results;
training a physics-informed graph neural network on the digital twin model to learn thermal stress patterns in the portion;
continuously monitoring temperature variations within the portion during industrial equipment operation;
inputting the temperature variations into the trained physics-informed graph neural network; and
receiving, as output, from the trained physics-informed graph neural network, a real-time assessment of accumulated thermal fatigue damage in the portion of the industrial equipment.

16. The method of claim 15, wherein the physics-informed graph neural network applies physical constraints based on the Laplace equation to ensure thermodynamically consistent damage predictions.

17. The method of claim 15, wherein the digital twin model comprises:
surface mesh data representing geometry of the portion;
internal flaw detection data from the ultrasonic testing; and
material property data for the portion.

18. The method of claim 15, further comprising:
establishing damage threshold limits for the portion;
comparing the real-time assessment of accumulated thermal fatigue damage to the damage threshold limits; and
generating an alert when the accumulated thermal fatigue damage exceeds a predetermined threshold limit.

19. The method of claim 15, wherein the continuously monitoring comprises:
sampling temperature data at the portion at intervals of less than one minute;
filtering noise from the temperature data; and
normalizing the temperature data for input into the physics-informed graph neural network.

20. The method of claim 15, further comprising:
calculating a rate of damage accumulation based on successive real-time assessments;
predicting remaining useful life of the portion of the industrial equipment based on the rate of damage accumulation; and
scheduling preventive maintenance based on the predicted remaining useful life.
